(19) United States
(12) Patent Application Publication
(10) Pub. No.: US 2011/0055297 A1
(43) Pub. Date: Mar. 3, 2011

(54) ACCESS MODULE, INFORMATION RECORDING MODULE, CONTROLLER, AND INFORMATION RECORDING SYSTEM

(76) Inventors: Takuji Maeda, Osaka (JP); Masayuki Toyama, Osaka (JP); Manabu Inoue, Osaka (JP); Toshiyuki Honda, Kyoto (JP)

(21) Appl. No.: 12/921,829

(22) PCT Filed: Mar. 4, 2010
(86) PCT No.: PCT/JP2010/001510

§ 371 Date: Sep. 10, 2010

(30) Foreign Application Priority Data
Mar. 13, 2009 (JP) 2009-060695

(51) Int. Cl. G06F 17/30

(52) U.S. Cl. 707/824; 707/E17.01

(57) ABSTRACT

A method for increasing the speed of processing when writing multiple files in parallel and writing file data in a stable manner in the case where the regions of a non-volatile memory in an information recording module are managed according to a filesystem is provided. An access module (1) includes a unit (104) that communicates, to an information recording module (2), information regarding the storage location of a directory entry, and also includes a unit (105) that pads file data when writing fractional data such as the end of a file and writes that data into the information recording module (2). Upon determining that the directory entry is to be written based on the communicated information, the information recording module (2) stores the directory entry in a dedicated physical block. Furthermore, the access module (1) pads the data of multiple files as necessary and records those files in continuous addresses in units that are a multiple of a predetermined size of a unit of recording processing.

### TECHNICAL FIELD

The present invention relates to an access module, an information recording module, a controller, and an information recording system that store data in a non-volatile memory and manage the data as files.

### BACKGROUND ART

Various types of recording media for recording digital data such as audio content, video data, and so on exist, such as magnetic disks, optical disks, magneto-optical disks, and so on. Of such recording media, memory cards that use semiconductor memories such as flash ROMs or the like as their recording elements have quickly become widespread among small-sized mobile devices such as digital still cameras, mobile telephone terminals, and so on due to their ability to reduce the size of the recording medium. Furthermore, in addition to functioning as removable media as conventional memory cards, semiconductor memories are also recently being used for built-in storage in devices, whereby semiconductor memories such as flash ROMs or the like are installed within devices instead of hard disks.

Semiconductor elements called NAND flash memories are primarily used in such memory cards, built-in storage in devices, and so on. NAND flash memories are recording elements cable of recording different data after data that has already been recorded is erased, and like conventional hard disks, are capable of being configured as information recording apparatuses that can be rewritten multiple times.

Thus far, data stored in memory cards, built-in storage in devices, and so on has been managed using filesystems. Managing data using a filesystem makes it possible to share data as files among devices that handle the same filesystem, and thus a user can easily use multiple devices to refer to or copy data that he/she has stored him/herself.

The filesystem most widely used thus far is called the FAT filesystem. A feature of the FAT filesystem is that it performs the uniform management of regions using a table called a file allocation table (FAT), and is widely used as the filesystem for Floppy® discs, hard disks in PCs, memory cards, and so on due to its comparatively simple structure and ease of implementation.

FIG. 2 illustrates the structure of the FAT filesystem. Although multiple types of FAT filesystems, such as FAT 12, FAT 16, FAT 32, and so on exist based on differences in the bit widths of the units of management within the file allocation table, the methods by which regions are managed by the file allocation tables are essentially the same, and thus FAT 16 will be used as an example hereinafter.

As shown in FIG. 2, a filesystem management information region 301, which is a region in which filesystem management information such as the unit by which regions are allocated, the size of the regions managed by the filesystem, and so on is stored, is present at the start of a logical address space. The filesystem management information region 301 contains filesystem management information called a master boot record partition table (MBR) 303, a partition boot sector (PBS) 304, FATs (305 and 306), and a root directory entry (RDE) 307, in each of which is stored information necessary for managing a user data region 302.

The master boot record partition table 303 is a region that holds information for managing regions called partitions, obtained by dividing a region in the logical address space managed by the filesystem into multiple regions. The partition boot sector 304 is a region that holds management information of a single partition, such as the size of the unit by which the regions within the partition are managed and so on.

The FATs (305 and 306) are regions that hold information regarding the storage locations of data contained in files; normally, two FATs (305 and 306) hold the same information duplicated, so that even if one of the FATs (305 or 306) fails, the files can be accessed through the other FAT (305 or 306). The root directory entry 307 is a region that holds files and directory information (directory entries) immediately below the root directory.

Furthermore, the FAT filesystem also includes the user data region 302, which holds, in a region continuing from the filesystem management information region 301, the actual data of the file. The user data region 302 is divided into and managed as units of management called clusters, each of which has a size of approximately 512 bytes to 32 KB, and each cluster holds data that belongs to the file. Files that hold a large amount of data hold that data across multiple clusters, and the connections between those clusters are managed using link information that is held in the FATs (305 and 306). Meanwhile, the files and subdirectory information (directory entries) present within the directory immediately below the root directory are stored using part of this user data region 302.

FIG. 3 is a diagram illustrating the configuration of an FAT 16 directory entry. A 32-byte directory entry 308 is allocated for a single file and directory, and the directory entry 308 holds information regarding the file and the directory. In other words, each time a single file or directory is added, the 32-byte directory entry 308 information is newly created and is recorded into a region in the root directory entry 307 or the user data region 302.

The first 8 bytes of the directory entry 308 hold the name of the file or directory. The next 3 bytes hold an extension. The next byte after that holds attribute information such as a flag identifying the type of the file/directory, a flag identifying whether or not the file/directory is read-only, and so on. Bytes holding information indicating the last update date/time of the file/directory, a starting cluster number indicating the starting position of the clusters that hold the actual file/directory, the number of bytes indicating the file size, and so on are held as well.

In this manner, the directory entry 308 does not hold information regarding the position of the cluster in which the starting data of the file is stored, and thus in the case where the file data is spread out among multiple clusters, that position information is held in the FATs (305 and 306). In other words, when updating the file, it is necessary to write the information of the directory entry 308 and FATs (305 and 306) as well as write the file data.

Next, a file data writing process performed in the FAT filesystem will be described using FIG. 4.

(S401):

The directory entry 308 of the target file is read out.

(S402):

The starting cluster number held in the directory entry 308 that has been read out is obtained and the starting position of the file data confirmed.

(S403):

The FATs (305 and 306) are read out into the access module of a RAM and the links within the FATs (305 and 306) in the RAM are followed in order starting with the starting position of the file data obtained in S402, thus obtaining the cluster number at the write position.

(S404):

It is determined whether or not it will be necessary to allocate a new empty region for the file when writing the file data. In the case where it is necessary to allocate a new empty region, the process advances to S405. However, in the case where it is not necessary to allocate a new empty region, the process advances to S408.

(S405):

An empty region is searched for within the FATs (305 and 306) in the RAM, and a single-cluster empty region is obtained. In the FATs (305 and 306), an FAT entry whose value is set at 0x0000 indicates an empty cluster, and thus the process for obtaining an empty region is a process in which an FAT entry whose value is 0x0000 within the FATs (305 and 306) is obtained. To be more specific, the FAT entries within the FATs (305 and 306) in the RAM are checked in order, an FAT entry whose value is set at 0x0000 is obtained, and the value of the corresponding cluster number of that FAT entry is found. The process for searching the FAT entries may, for example, be carried out in order from the start of the FATs (305 and 306) to the end of the FATs (305 and 306), or the process may be commenced from the FAT entry following the FAT entry to which an empty region was allocated the previous time, returning to the start of the FATs (305 and 306) when the end of the FATs (305 and 306) has been reached, and performing the process up until the FAT entry to which an empty region was allocated the previous time. In this manner, the process for searching the FAT entries is not particularly limited, and any process that enables the entirety of the regions of the FATs (305 and 306) to be searched for an empty region may be used.

(S406):

The value of the FAT entry corresponding to the number of the empty cluster obtained in S405 is set as a value indicating a link end. In the FATs (305 and 306), the FAT entry whose value is set to 0xFFFF indicates a link end, and thus a process for setting the value of that FAT entry in the RAM as 0xFFFF is carried out in S406.

(S407):

The value of the FAT entry corresponding to the cluster number of the current link end is set in the RAM from 0xFFFF to the number of the empty cluster obtained in S405. When it is necessary to obtain an empty region, this indicates an addition to the end of the file, and thus in such a case, the links are followed to the file end in the process for following the links performed in S403. For this reason, the value of the FAT entry corresponding to the cluster number at the current link end is set to 0xFFFF, indicating the link end. Accordingly, as a result of the process of S407, the linking continues to the empty cluster newly obtained in S405, thus lengthening the file links by one cluster's worth, which makes it possible to add file data.

(S408):

The file data is written into the cluster in the write position currently being referred to. In the case where it has been determined in S404 that it is necessary to obtain an empty region, the write position currently referred to is the empty cluster obtained in S405. On the other hand, in the case where it has been determined in S404 that it is not necessary to obtain an empty region, the write position currently referred to is the cluster reached as a result of following the links in S403.

(S409):

It is determined whether all the file data has been written. If file data still remains, the process returns to S404. However, if all the file data has been written, the process advances to S410.

(S410):

The information held within the directory entry 308, such as the file size, the last update date/time, and so on is updated, and the directory entry 308 held in the non-volatile memory of the information recording module is overwritten.

(S411):

The FATs (305 and 306) held in the non-volatile memory of the information recording module are overwritten with the data of the FATs (305 and 306) in the RAM of the access module, and the process ends.

Through this file data writing process, when, as shown in FIG. 5, 10,000 bytes of data is added to a FILE1.TXT that has 60,000 bytes of data, the file changes to a file having 70,000 bytes of data, as shown in FIG. 6. In other words, a cluster having a cluster number of 6 is obtained as the empty cluster, file data is added, and the links in the FATs (305 and 306) continue to the cluster number 6. As a result, the links in the FILE1.TXT are updated from a state made up of four clusters, or clusters number 2 through 5, to five clusters, or clusters number 2 through 6.

In this manner, with the FAT filesystem, the file management information is held in both the FATs (305 and 306) and the directory entry 308, and thus it is necessary to update the information in both when updating the file. In other words, when the access module updates a file held in the information recording module, a series of writing processes, such as file data (DATA), directory entry 308 (DIR), and FATs (305 and 306) (FAT1 and FAT2) as shown in FIG. 7, is carried out.

Meanwhile, one feature of NAND flash memories is that it is necessary to erase the data thereof prior to recording data. Accordingly, when carrying out a write of a size less than the size of a block, which is the unit by which data is erased, that block cannot be directly overwritten; thus it is necessary to obtain a different, unused block, erase the data within the block, and then write the new data into that block. At this time, it is necessary to copy the valid data in the old block into the new block, which reduces the recording speed. Because the amount that is copied increases as the data write size decreases, and because the data write size decreases as it approaches the block size, it is generally known that the recording speed is highest in NAND flash memories when writing data in block-size units.

A conventional method has been disclosed in which the real-time recording of video content or the like is realized by increasing the speed of recording into a NAND flash memory and preventing a drop in the recording speed caused by the aforementioned copy process (for example, see Patent Citation 1). In this method, when regions in the flash memory are divided into block units, only blocks in which the number of empty regions (empty clusters) is high are obtained, and data such as video content is recorded. Doing so eliminates data copying within blocks and prevents a drop in the recording speed.

### Citation List

### Patent Literature

Patent Citation 1: International Publication WO05/055064

### SUMMARY

### Technical Problem

However, when updating the FATs (305 and 306), the directory entry 308, and so on, there is the possibility that the recording address moves across multiple blocks, and thus the aforementioned conventional technique cannot prevent a drop in speed. For example, with devices that record movies and the like, in the case where the power supply has been interrupted during the recording of file data and the directory entry 308, FATs (305 and 306), and so on could not be updated, the file data recorded up until that point is lost; thus the directory entry 308, the FATs (305 and 306), and so on are updated periodically, every several seconds or so. When recording the data (DATA), directory entry 308 (DIR), and the FATs (305 and 306) (FAT1 and FAT2) of a single file as shown in FIG. 7 with such a device, update recording of the directory entry 308, the FATs (305 and 306), and so on occurs between the intervals of the data recording, and thus at that point in time, a drop in speed has already occurred.

Furthermore, in the case where multiple files are recorded in parallel, such as when recording a still image file during the recording of video, there is the possibility that the recording address will move across multiple blocks, and thus a drop in the recording speed cannot be prevented in this case as well. For example, as shown in FIG. 8, in the case where data (DATA1) of the first file and data (DATA2) of the second file are recorded, there is the possibility that the recording address will move across multiple blocks. Furthermore, in this case, because the directory entries 308 (DIR1 and DIR2) of the respective files are sometimes held at different addresses, there is the possibility that the recording address will move across multiple blocks here as well.

Having been achieved in light of the aforementioned problems, it is an object of the present invention to provide an access module, an information recording module, a controller, and an information recording system that prevent a drop in speed, even in a case such as where multiple files are recorded into a NAND flash memory in parallel, and achieve real-time recording.

### Solution to Problem

An access module according to the present invention is an access module that accesses an information recording module having a non-volatile memory that stores data, and includes: an address management information setting processing unit that communicates, to the information recording module, location information indicating a region that stores data of a predetermined data type; and a data shaping processing unit that, in the case where valid data of file data to be recorded into the information recording module is smaller in size than a predetermined unit of recording processing, changes the size of the file data to the size of the predetermined unit of recording processing by adding arbitrary data to the file data, and records the file data into the information recording module.

Meanwhile, in the case where file data of multiple files is recorded into the information recording module in parallel, it is effective for the file data of the multiple files to be arranged in an arbitrary order and recorded into the information recording module so that addresses of the file data are continuous within a predetermined continuous region size.

In addition, the predetermined data type may be filesystem management information that includes information such as the name, file size, or the like of the file to be recorded.

Furthermore, the predetermined data type may be filesystem management information that includes information such as the name, file size, or the like of the file to be recorded; and the address management information setting processing unit may communicate multiple pieces of location information indicating regions in which the filesystem management information is stored to the information recording module.

In addition, in the case where arbitrary data has been added to the file data recorded into the information recording module, it is preferable for the size of the valid data before the arbitrary data was added to be set as the file size in the filesystem management information that includes information such as the name, the file size, or the like of the file.

In addition, it is preferable for the size of the predetermined unit of recording processing to be a multiple of the physical size of the unit of data recording processing of the non-volatile memory included in the information recording module.

Furthermore, it is preferable for the predetermined continuous region size to be a multiple of the physical size of the unit of data erasing processing of the non-volatile memory included in the information recording module.

An information recording module according to the present invention includes: a non-volatile memory that stores data; address management information that holds location information indicating a region in which is stored data of a predetermined data type specified by an external access module; and an entry storage control unit that, in the case where it has been determined based on the address management information that data of the predetermined data type is to be recorded, stores the data in a specific region within the non-volatile memory.

In addition, it is preferable for the predetermined data type to be filesystem management information that includes information such as the name, file size, or the like of the file to be recorded.

Furthermore, the predetermined data type may be filesystem management information that includes information such as the name, file size, or the like of the file to be recorded; and the address management information may hold multiple pieces of location information indicating regions in which the filesystem management information is stored.

In addition, it is preferable for the entry storage control unit to allocate a specific region to each piece of location information, indicating regions in which the filesystem management information is stored, that is held in the address management information, and store the filesystem management information in the specific regions.

In addition, it is effective for the address management information to further include location information of a region that stores data of a second data type that is different from the predetermined data type; and for the entry storage control unit to further perform a process that, in the case where it has been determined based on the address management information that data of the second data type is to be recorded, stores the data in a specific region within the non-volatile memory that is different from the region in which the data of the predetermined data type is stored.

In addition, it is preferable for the second data type to be region management information used by a filesystem.

A controller according to the present invention is a controller that controls an information recording module having a non-volatile memory that stores data, and includes: an entry storage control unit that refers to address management information that holds location information of a region in which data of a predetermined data type specified by an external access module is stored, and in the case where it has been determined that data of the predetermined data type is to be recorded, stores the data in a specific region within the non-volatile memory.

An information recording system according to the present invention includes an information recording module and an access module that accesses the information recording module. The information recording module has: a non-volatile memory that stores data; address management information that holds location information indicating a region in which is stored data of a predetermined data type specified by the access module; and an entry storage control unit that, in the case where it has been determined based on the address management information that data of the predetermined data type is to be recorded, stores the data in a specific region within the non-volatile memory. The access module has: an address management information setting processing unit that communicates, to the information recording module, location information indicating a region that stores data of the predetermined data type; and a data shaping processing unit that, in the case where valid data of file data to be recorded into the information recording module is smaller in size than a predetermined unit of recording processing, changes the size of the file data to the size of the predetermined unit of recording processing by adding arbitrary data to the file data, and records the file data into the information recording module.

### Advantageous Effects

According to the present invention, it is possible to prevent a drop in speed, even in a case such as where multiple files are recorded into a NAND flash memory in parallel, and achieve real-time recording.

### BRIEF DESCRIPTION OF DRAWINGS

FIG. 1 is a diagram illustrating the configuration of an access module and an information recording module according to a first embodiment.

FIG. 2 is a diagram illustrating the structure of the FAT filesystem.

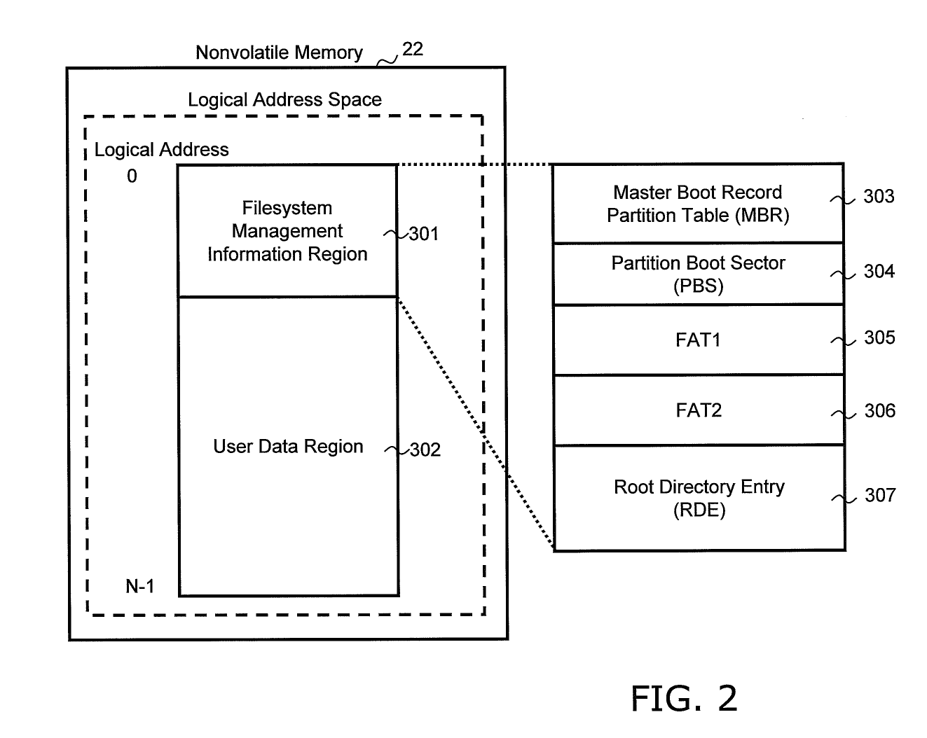

FIG. 3 is a diagram illustrating the structure of a directory entry.

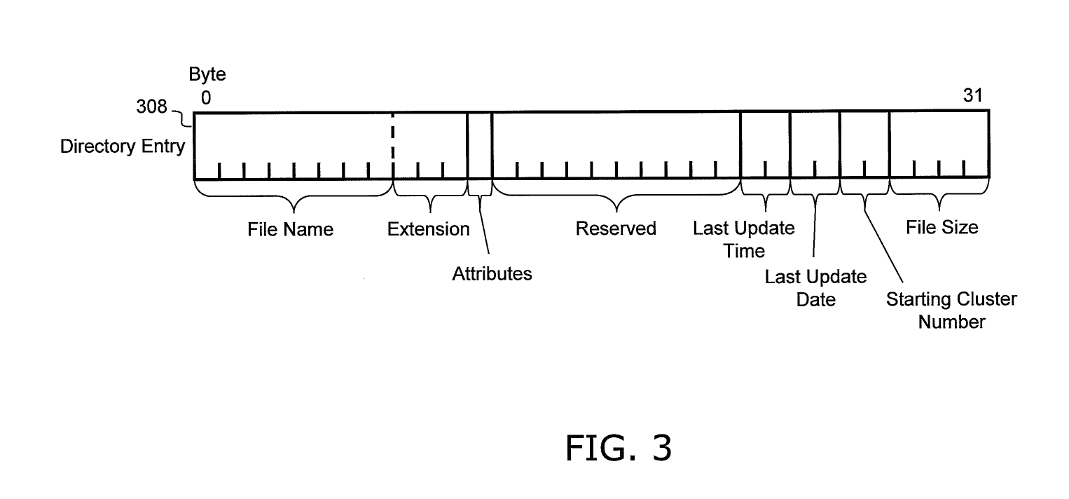

FIG. 4 is a flowchart illustrating the procedure of a file data writing process in the FAT filesystem.

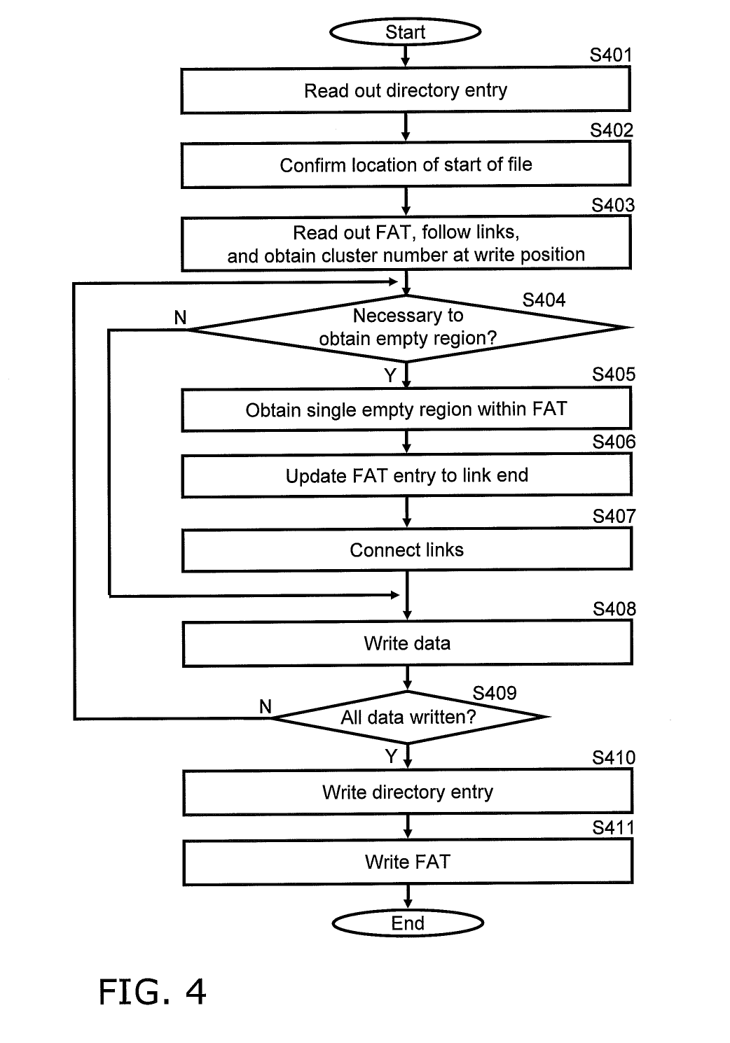

FIG. 5 is a diagram illustrating an example of a state prior to a file data writing process in the FAT filesystem.

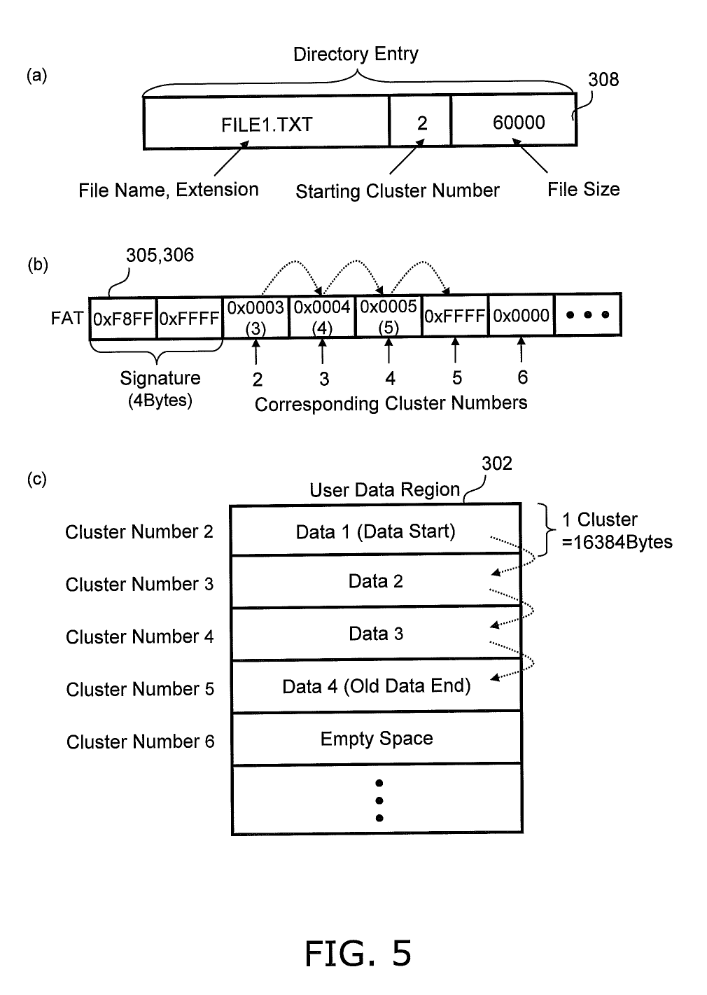

FIG. 6 is a diagram illustrating an example of a state following a file data writing process in the FAT filesystem.

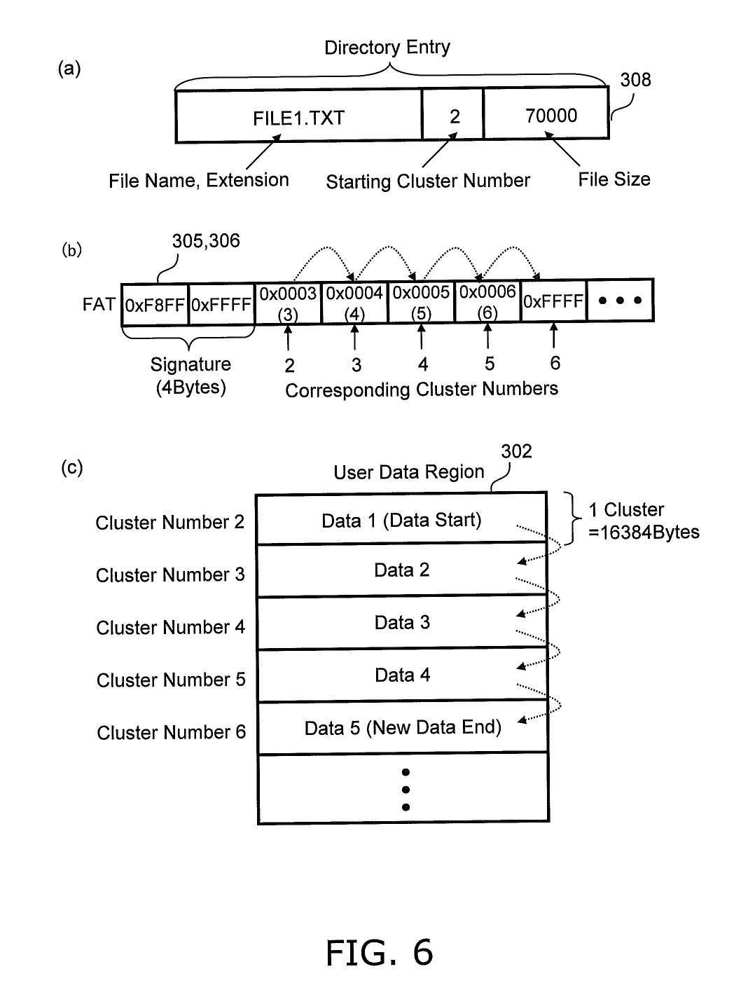

FIG. 7 is a diagram illustrating an example of a recording procedure in the case where a single file is recorded in the FAT filesystem.

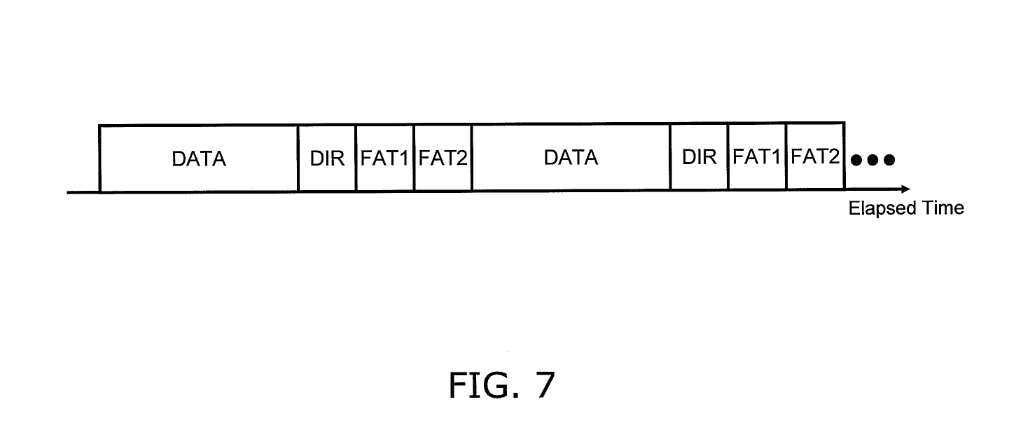

FIG. 8 is a diagram illustrating an example of a recording procedure in the case where two files are recorded in parallel in the FAT filesystem.

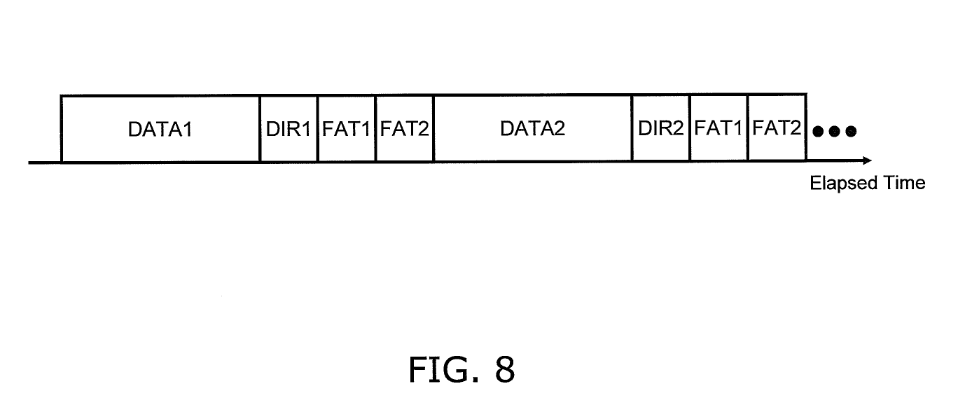

FIG. 9 is a diagram illustrating an example of the structure of a non-volatile memory according to the first embodiment.

FIG. 10 is a diagram illustrating an example of a relationship between logical addresses and physical addresses within the non-volatile memory according to the first embodiment.

FIG. 11 is a diagram illustrating an example of the structure of address management information according to the first embodiment.

FIG. 12 is a diagram illustrating an example of a data arrangement when recording multiple files in parallel according to the first embodiment.

FIG. 13 is a flowchart illustrating the overall procedure of a data write process according to the first embodiment.

FIG. 14 is a flowchart illustrating the detailed procedures of the data write process according to the first embodiment.

FIG. 15 is a diagram illustrating an example of a write sequence when writing multiple files in parallel according to the first embodiment.

FIG. 16 is a flowchart illustrating the procedure of a directory entry write process performed by an entry storage control unit according to the first embodiment.

FIG. 17 is a diagram illustrating an example of the state of a first entry storage region according to the first embodiment.

FIG. 18 is a flowchart illustrating the procedure of an FAT write process performed by an FAT storage control unit according to the first embodiment.

FIG. 19 is a diagram illustrating an example of the state of an FAT storage region according to the first embodiment.

FIG. 20 is a flowchart illustrating the procedure of a user data write process performed by a user data storage control unit according to the first embodiment.

FIG. 21 is a diagram illustrating an example of the state of a user data storage region according to the first embodiment.

FIG. 22 is a diagram illustrating another example of the state of a user data storage region according to the first embodiment.

### DESCRIPTION OF EMBODIMENT

An access module, an information recording module, a controller, and an information recording system according to the present invention will be described hereinafter with reference to the drawings.

### First Embodiment

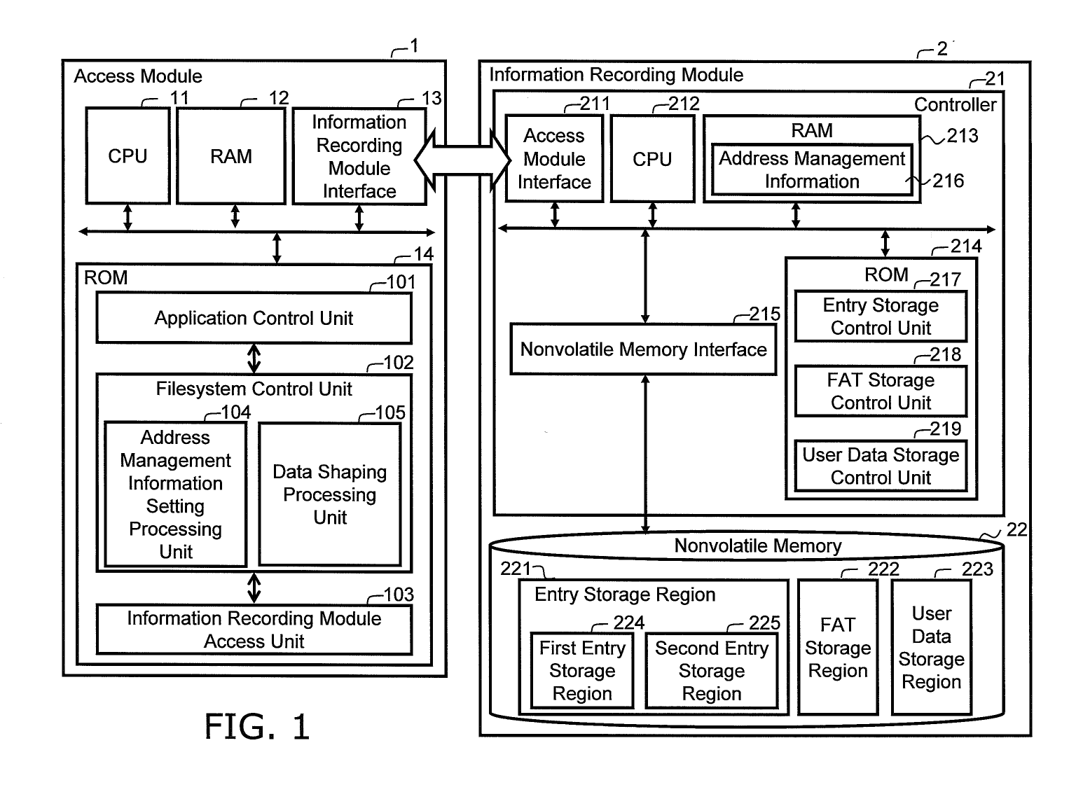

FIG. 1 is a diagram illustrating the configuration of an access module 1 and an information recording module 2 according to a first embodiment.

The access module 1 shown in FIG. 1 includes a CPU 11, a RAM 12, an information recording module interface 13, and a ROM 14. A program for controlling the access module 1 is stored in the ROM 14, and the program is run by the CPU 11 using the RAM 12 as a temporary storage region. The information recording module interface 13 serves as a connection unit between the information recording module 2 and the access module 1, and exchanges control signals and data.

The ROM 14 further includes an application control unit 101, a filesystem control unit 102, and an information recording module access unit 103. The application control unit 101 carries out control of the access module 1 as a whole, generating data, controlling the power thereof, and so on. The filesystem control unit 102 carries out control for managing data as files through a filesystem such as the FAT filesystem. The information recording module access unit 103 is provided with a size and an address along with data from the filesystem control unit 102, and controls the exchange of commands, data, and so on with the information recording module 2, recording data of a specified size into a specified location within a non-volatile memory of the information recording module 2 and so on.

The filesystem control unit 102 further includes an address management information setting processing unit 104 and a data shaping processing unit 105. The address management information setting processing unit 104 is a processing unit that carries out a process for, when data is recorded into a file, communicating information regarding the location of a directory entry 308 of that file to the information recording module 2, and does not exist in conventional access modules. Meanwhile, the data shaping processing unit 105 is a processing unit that pads data and records the padded data into the information recording module 2 in the case where the size of the data to be recorded into the file is not a multiple of the unit used for recording into the information recording module 2, and, like the address management information setting processing unit 104, does not exist in conventional access modules. These processing units will be described in greater detail later.

Meanwhile, the information recording module 2 shown in FIG. 1 includes a controller 21 and a non-volatile memory 22.

The controller 21 is a module that carries out the overall control of the non-volatile memory 22, and is configured as a system LSI that includes a CPU and the like. The controller 21 further includes an access module interface 211, a CPU 212, a RAM 213, a ROM 214, and a non-volatile memory interface 215. The access module interface 211 serves as a connection unit between the information recording module 2 and the access module 1, and like the information recording module interface 13, is an interface that exchanges control signals and data. A program for controlling the information recording module 2 is stored in the ROM 214, and the program is run by the CPU 212 using the RAM 213 as a temporary storage region. The non-volatile memory interface 215 serves as a connection unit between the controller 21 and the non-volatile memory 22, and controls the exchange of commands, data, and so on with the non-volatile memory 22.

The ROM 214 further includes an entry storage control unit 217, an FAT storage control unit 218, and a user data storage control unit 219. The entry storage control unit 217 is a control unit that, in the case where a data write command issued by the access module 1 to the information recording module 2 indicates a process for writing specific data corresponding to a directory entry, carries out a process for storing that data within an entry storage region 221. The FAT storage control unit 218 is a control unit that, in the case where the data write command indicates a process for writing specific data corresponding to an FAT, carries out a process for storing that data within an FAT storage region 222. The user data storage control unit 219 is a control unit that, in the case where the data write command indicates a process for writing other data, carries out a process for storing that data in a user data storage region 223.

Although the process performed by the user data storage control unit 219 is essentially the same as processing handled by the conventional information recording module 2, the processes performed by the entry storage control unit 217 and the FAT storage control unit 218 do not exist in the conventional information recording module 2. Details of these control units will be given later.

Meanwhile, the RAM 213 includes address management information 216, which is used by the entry storage control unit 217, the FAT storage control unit 218, and the user data storage control unit 219 as control information.

In addition, the non-volatile memory 22 includes the entry storage region 221, the FAT storage region 222, and the user data storage region 223 mentioned earlier, and the entry storage region 221 further includes a first entry storage region 224 and a second entry storage region 225.

The information recording module 2 according to the present embodiment uses the entry storage region 221, the FAT storage region 222, and the user data storage region 223 within the non-volatile memory 22 as different data storage destinations depending on the type of data. Meanwhile, in the case where multiple files are recorded in parallel, data obtained by padding the data of the multiple files to a length that is a multiple of a predetermined write process unit is recorded, in block units, into sequential address regions. Furthermore, the access module 1 according to the present embodiment includes the address management information setting processing unit 104, which communicates location information of the directory entry 308 to the information recording module 2, and the data shaping processing unit 105, which pads fractional data and records that data into the information recording module 2. Combining the access module 1 and the information recording module 2 eliminates wasteful copying processes that occur within the information recording module 2 and prevents a drop in the recording speed even in the case where multiple files are recorded in parallel, making it possible to quickly and stably record data into the information recording module 2.

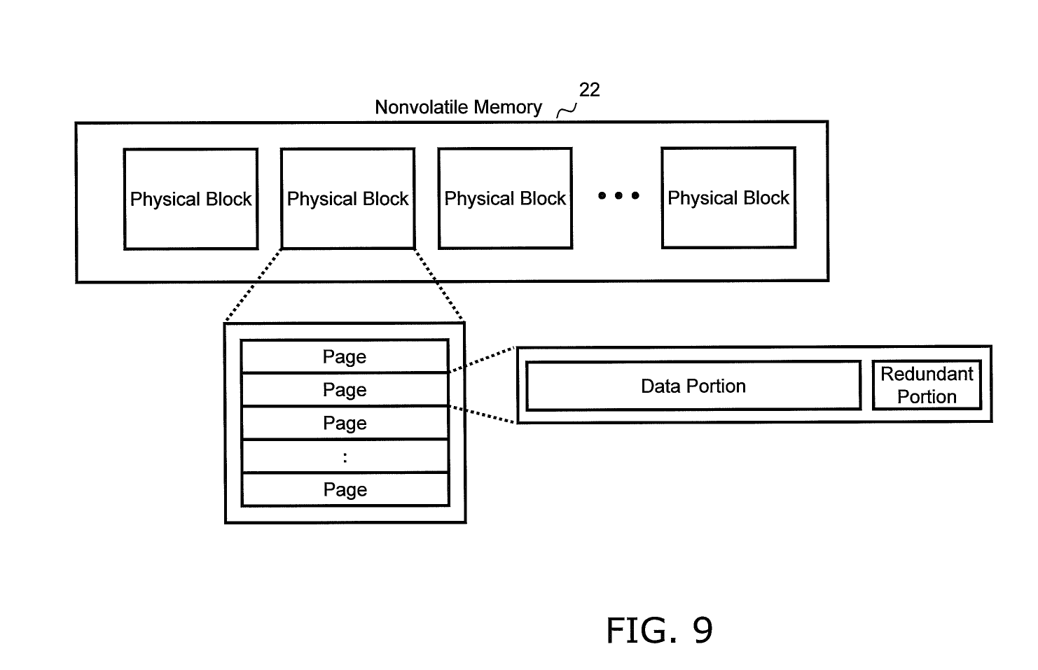

The configuration of the non-volatile memory 22 according to the present embodiment will now be described using FIG. 9. A NAND flash memory or the like, for example, is used as the non-volatile memory 22. The non-volatile memory 22 is configured from multiple physical blocks. A physical block is a unit by which data is erased, and it is necessary to erase data in these units prior to writing data. Each physical block, meanwhile, is configured from multiple pages. A page is a unit by which data is written. Furthermore, each page includes a data portion and a redundant portion. The data portion is a region capable of being accessed by the access module 1 as a logical address space, and is a region in which file data or the like is actually stored. The redundant portion, meanwhile, is a region in which management information, ECCs, and so on of the non-volatile memory 22 are stored, and is a region that cannot be accessed by the access module 1. The size of the data portion is, for example, 4 KB, whereas the size of the redundant portion is approximately 128 bytes. Focusing only on the data portion, the size of a physical block is, for example, approximately 512 KB. Therefore, when the non-volatile memory 22 is, for example, configured of 2,048 physical blocks of that size, the capacity of the non-volatile memory 22 is 1 GB.

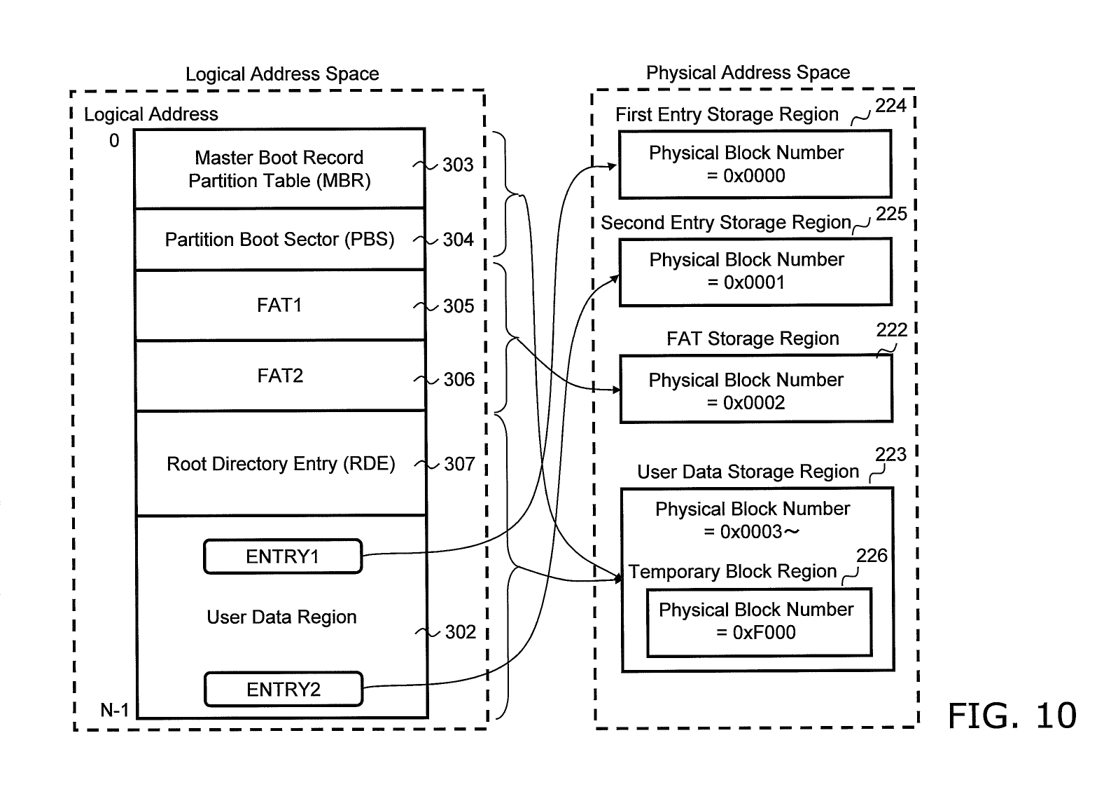

Relationships between logical addresses and physical addresses within the non-volatile memory 22 according to the present embodiment will now be described using FIG. 10. Logical addresses and physical addresses are present as addresses within the non-volatile memory 22. A logical address is a virtual address that is used when the access module 1 accesses the information recording module 2. A physical address, meanwhile, indicates an actual address allocated to all of the physical blocks within the non-volatile memory 22, and this physical address is used when accessing the non-volatile memory 22 within the information recording module 2. Logical addresses are associated with physical addresses, and the correspondence relationship therebetween is managed by the address management information 216 within the RAM 213 of the information recording module 2.

FIG. 10 is a diagram illustrating an example of correspondence relationships between logical addresses and physical addresses within the non-volatile memory 22. Filesystem management information and the like, such as a master boot record partition table, is stored within a logical address space, thus constructing a filesystem. The first entry storage region 224, the second entry storage region 225, the FAT storage region 222, the user data storage region 223, and so on are present within a physical address space.

The first entry storage region 224 is a dedicated physical block in which the directory entry 308 of the first file (an “ENTRY1” in the logical address space) is stored, and in the example shown in FIG. 10, a physical block number of 0x0000 is allocated thereto. The second entry storage region 225, meanwhile, is a dedicated physical block in which the directory entry 308 of the second file (an “ENTRY2” in the logical address space) is stored, and in the example shown in FIG. 10, a physical block number of 0x0001 is allocated thereto. The FAT storage region 222 is a dedicated physical block in which the FATs (305 and 306) are stored, and in the example shown in FIG. 10, a physical block number of 0x0002 is allocated thereto. The user data storage region 223 is a physical block in which other data is stored, and in the example shown in FIG. 10, the regions of physical block numbers 0x0003 and on are allocated thereto. The user data storage region 223 further includes a temporary block region 226, which is a physical block that is temporarily used when updating data in the user data storage region 223. In the example shown in FIG. 10, a physical block number of 0xF000 is allocated to the temporary block region.

As shown in FIG. 10, the information recording module 2 according to the present embodiment manages the directory entry 308 and FATs (305 and 306) with dedicated physical blocks, and prevents a decrease in speed during data recording by carrying out a special write process.

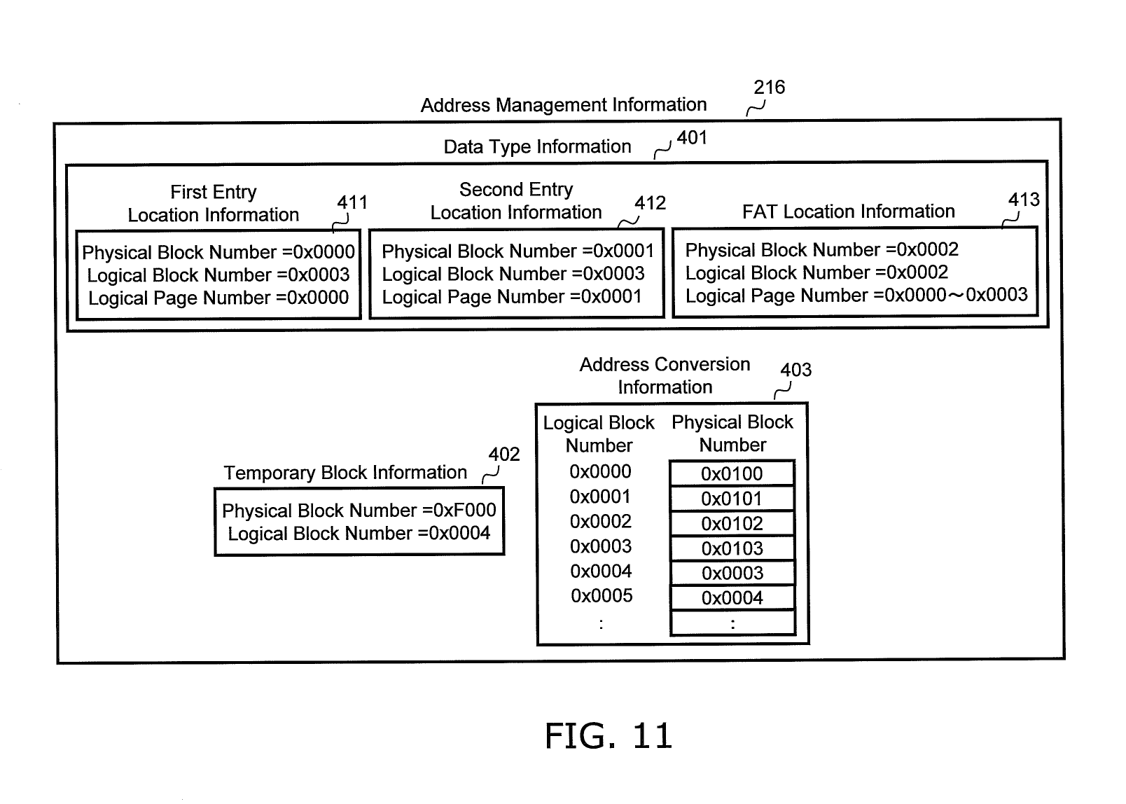

The address management information 216 according to the present embodiment will be described next using FIG. 11. The address management information 216 includes data type information 401, temporary block information 402, and address conversion information 403. The data type information 401 includes first entry location information 411 serving as management information used to control the first entry storage region 224, second entry location information 412 serving as management information used to control the second entry storage region 225, and FAT location information 413 serving as management information used to control the FAT storage region 222.

The first entry location information 411 is information regarding the storage location of the first directory entry 308, and is configured of the physical address (physical block number) and the logical address (logical block number, logical page number) in which that directory entry 308 is stored. This logical address is communicated to the information recording module 2 by the address management information setting processing unit 104 of the access module 1. Meanwhile, the second entry location information 412 is information regarding the storage location of the second directory entry 308, and the content thereof is the same as the first entry location information 411. Finally, the FAT location information is information regarding the storage location of the FATs (305 and 306), and is likewise configured of a physical address and a logical address. However, because the size of the FATs (305 and 306) is greater than the directory entry 308, the address information managed by the FAT location information 413 is multiple pages' worth of address information. The logical address of the FATs (305 and 306) is determined when the information recording module 2 is formatted and assumes a fixed value thereafter; for this reason, the FAT location information 413 may, like the first entry location information 411, be communicated to the information recording module 2 by the address management information setting processing unit 104 of the access module 1, or a pre-set logical address within the information recording module 2 may be used.

The temporary block information 402 is information regarding the state of the temporary block region 226 within the user data storage region 223, and is configured of information of the physical address of the physical block that is currently allocated as the temporary block region 226, and a logical address associated with that physical block.

The address conversion information 403 is information indicating the correspondence relationships between the respective physical addresses and logical addresses of the physical blocks within the user data storage region 223. This information is the same as information held by the conventional information recording module 2, and is information that is generally called an “address conversion table”, a “logical address conversion chart”, and so on.

The entry storage control unit 217, the FAT storage control unit 218, and the user data storage control unit 219 according to the present embodiment control recording regions within the non-volatile memory 22 using this address management information 216. In other words, a drop in speed during data recording is prevented by storing the directory entry 308, the FATs (305 and 306), and so on through a special write process that uses dedicated physical blocks. Furthermore, the present embodiment also provides a method that prevents a drop in speed during data recording even in the case where multiple files are recorded in parallel.

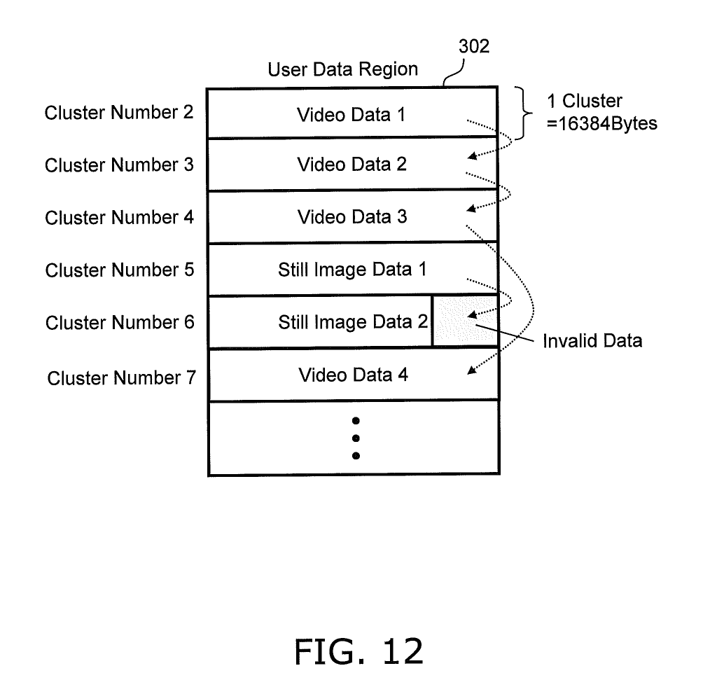

For example, in a case such as that shown in FIG. 12, where still image data is recorded during the recording of a video file, the still image data is recorded in addresses that continue from the video data. The example shown in FIG. 12 assumes that the unit of the write process is one cluster (=16 KB). In this case, after video data has been continuously recorded for three clusters, still image data is recorded in the following two clusters. At this time, because the size of the still image file is not necessarily a multiple of the size of a cluster, typically, no data is recorded in the portion indicated as invalid data in FIG. 12. However, in the present embodiment, user data is recorded in continuous addresses in multiples of the size of the unit of processing in order to record data into the non-volatile memory 22 at high speed. For this reason, still image data 2 that is recorded into cluster number 6 is padded by the data shaping processing unit 105 of the access module 1 so as to attain a size that is a multiple of the cluster size, and is recorded in the information recording module 2 as one cluster's worth of data. The size of the padding is adjusted when recording the directory entry 308 in the information recording module 2, and details of that process will be given later. Furthermore, after the still image data has been recorded, the recording of the video data continues.

In this manner, in the present embodiment, data is recorded into continuous addresses in multiples of the size of the unit of processing in the case where multiple files are recorded in parallel. Furthermore, a fractional size at the end of the file is padded so as to attain a multiple of the unit of processing, and is then recorded in the information recording module 2. As a result, it is possible to record data in the information recording module 2 at high speed, as if a single file is being continuously recorded.

Hereinafter, a detailed data recording procedure according to the present embodiment will be described.

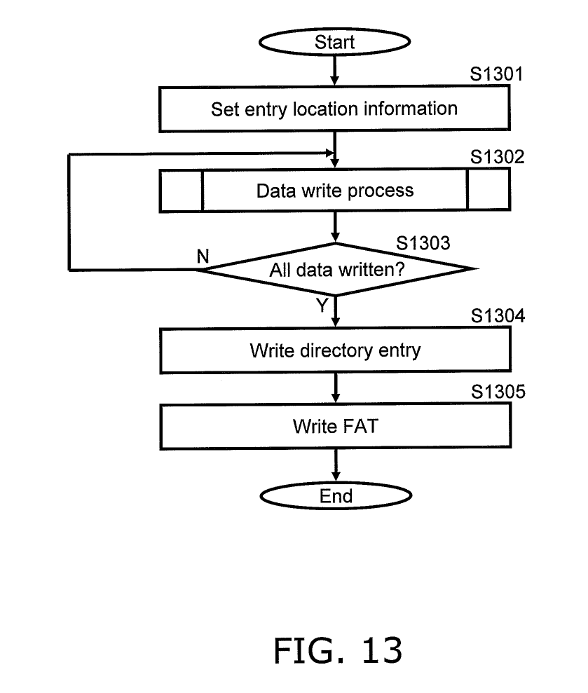

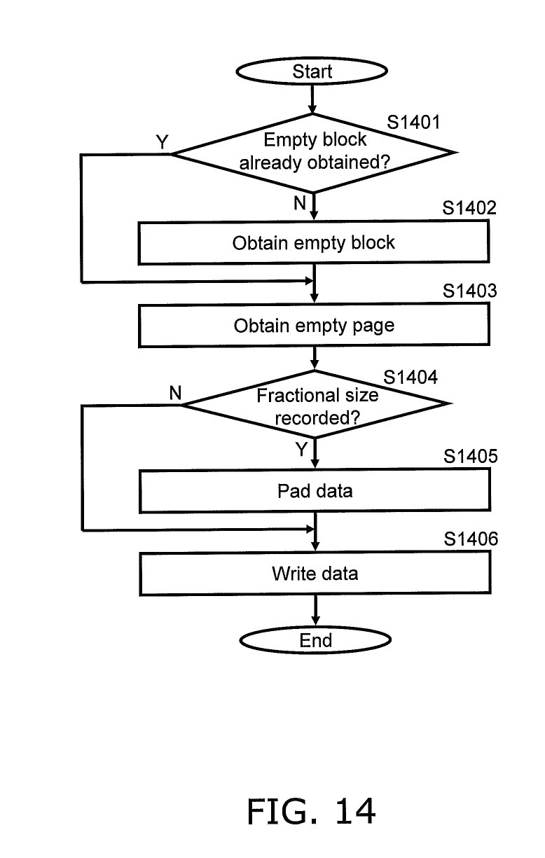

The procedures of a file writing process according to the present embodiment will now be described using FIGS. 13 and 14. FIG. 13 is a flowchart illustrating the overall procedure of a file write process according to the present embodiment, whereas FIG. 14 is a flowchart illustrating the detailed procedures of the data write process. The following describes a case in which writing is carried out using the page size unit as the unit of processing for recording in the information recording module 2 as an example.

(S1301):

The address management information setting processing unit 104 of the access module 1 communicates, to the information recording module 2, the location information of the directory entry 308 of the file to be recorded. The communicated information is stored in the first entry location information 411 or the second entry location information 412 in the address management information 216 within the RAM 213 of the information recording module 2. If the file to be recorded is the first file, the information is stored in the first entry location information 411, whereas if the file to be recorded is the second file, the information is stored in the second entry location information 412.

(S1302):

The data of the file to be recorded is written into the information recording module 2. At this time, in the case where the size of the write is not a multiple of the unit of recording processing, as with the end of a file or the like, the data shaping processing unit 105 of the access module 1 pads the data so as to attain a multiple of the unit of recording processing, and writes the data into the information recording module 2. Details of the content of this process are illustrated in FIG. 14.

(S1303):

It is determined whether all the file data has been written. If file data still remains, the process returns to S1302. However, if all the file data has been written, the process advances to S1304.

(S1304):

The directory entry 308 of the file to be recorded is written into the information recording module 2 having updated the information of the directory entry 308, such as the file size, the last update date/time, and so on. At this time, in the case where padding has been carried out in the process of S1302, the file size is set to a file size that is a fraction of the original file size. This makes it possible to store the file data in the information recording module 2 as a file of the original file size, even if the file data has been padded in S1302.

(S1305):

The link information within the FATs (305 and 306) is updated based on the data write process carried out in S1302 and is written into the information recording module 2.

Next, the procedure of the data write process indicated in FIG. 14 will be described in detail.

(S1401):

In the case where the user data region 302 in the logical address space has been divided into block units, it is determined whether an empty block that includes an empty region has already been obtained. In the case where an empty block has already been obtained, the process advances to S1403. However, in the case where an empty block has not yet been obtained, the process advances to S1402. In the present embodiment, when recording file data into the user data region 302, in the case where the user data region 302 has been divided into block units, it is assumed that a block in which all of the regions within the block are empty regions will be selected and the file data will be written continuously into that block in units of pages. For this reason, “an empty block already being obtained” refers to a state in which a given empty block has already been selected as the recording region and the process of writing the file data into that block has commenced. Conversely, “an empty block not yet being obtained” refers to a state immediately after file data has been written up to the end of a given empty block, and it is thus necessary to select a given empty block before writing new data.

(S1402):

In the case where it has been determined in the determination process of S1401 that an empty block has not yet been obtained, an empty block is obtained. To be more specific, the FATs (305 and 306) are referred to, and a process for finding a given block in which all the regions in the block are empty regions is carried out.

(S1403):

An empty page within the empty block is obtained. It is assumed that the recording of data into the empty block will be carried out continuously from the start of the region, and thus the first empty page that is present when searching the target block from the start is obtained as the empty page for recording. Meanwhile, the term “page” is used because the unit of recording processing is the page, and thus in the case where the recording is carried out using a unit aside from the page size as the unit of the recording processing, an empty region of the size of that unit of recording processing is obtained in this process.

(S1404):

It is determined whether the size of the data to be recorded is the same as the page size. In the case where the size is not the same as the page size and is instead a fractional size, the process advances to S1404. On the other hand, in the case where the size is exactly the same as the page size, the process advances to S1406. As with S1403, in the case where the unit of recording processing is not the page size unit, this process is a process in which the size of the data to be recorded and the size of the unit for the recording processing are compared.

(S1405):

The data shaping processing unit 105 pads the data to be recorded so that the size of the data to be recorded is the same as the page size. The padding data may be a fixed value, such as 0x00 or 0xFF, or may be an arbitrary value.

(S1406):

The page-size data is written into the information recording module 2, and the processing ends.

The size of the block, the page, and so on used in the descriptions of FIG. 14 may be obtainable by the access module 1 from the information recording module 2, or a fixed value may be determined in advance and used in the access module 1.

As described thus far using FIGS. 13 and 14, in the present embodiment, data is recorded into continuous addresses in multiples of the size of the unit of processing in the case where multiple files are recorded in parallel. Furthermore, a fractional size at the end of the file is padded so as to attain a multiple of the unit of processing, and is then recorded in the information recording module 2. As a result, it is possible to record data in the information recording module 2 at high speed, as if a single file is being continuously recorded. Meanwhile, although a case in which the writing of the directory entry 308, the FATs (305 and 306), and so on is carried out collectively at the end of the file has been described here as an example, such writing may be carried out between file data recording intervals, such as periodically performing updates every several seconds.

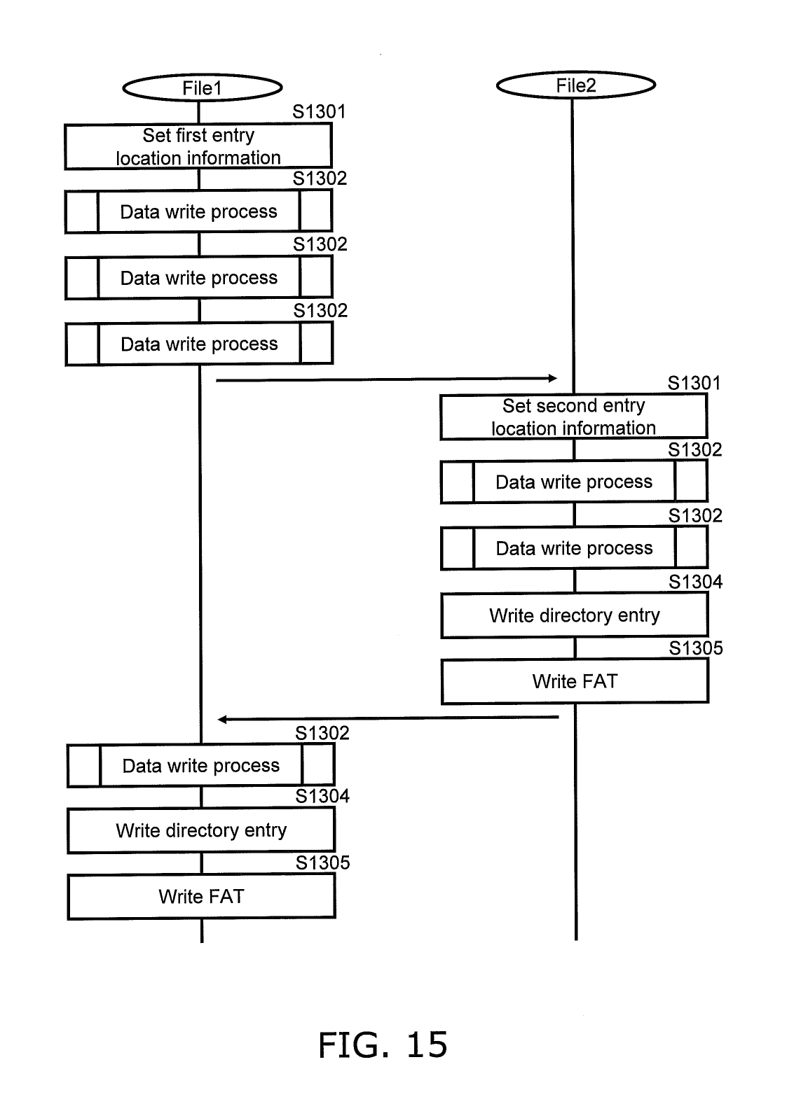

FIG. 15 is a diagram illustrating an example of a write sequence when writing multiple files in parallel according to the present embodiment. In FIG. 15, File1 indicates the first file, whereas File2 indicates the second file. This example illustrates a case in which the second file is recorded during the data recording of the first file, and corresponds to, for example, a process performed in the case where a still image file is recorded during the recording of a video file. In this case, the recording process of the second file is switched to during the recording of the first file in accordance with the process illustrated in FIG. 13, and after the recording of the second file is complete, the recording process of the first file is resumed. However, because the data of these two files is recorded into continuous addresses within a given block in accordance with the processes illustrated in FIGS. 13 and 14, the recording speed does not drop even if the file that is being recorded is switched, and it is thus possible to record the data in a stable manner.

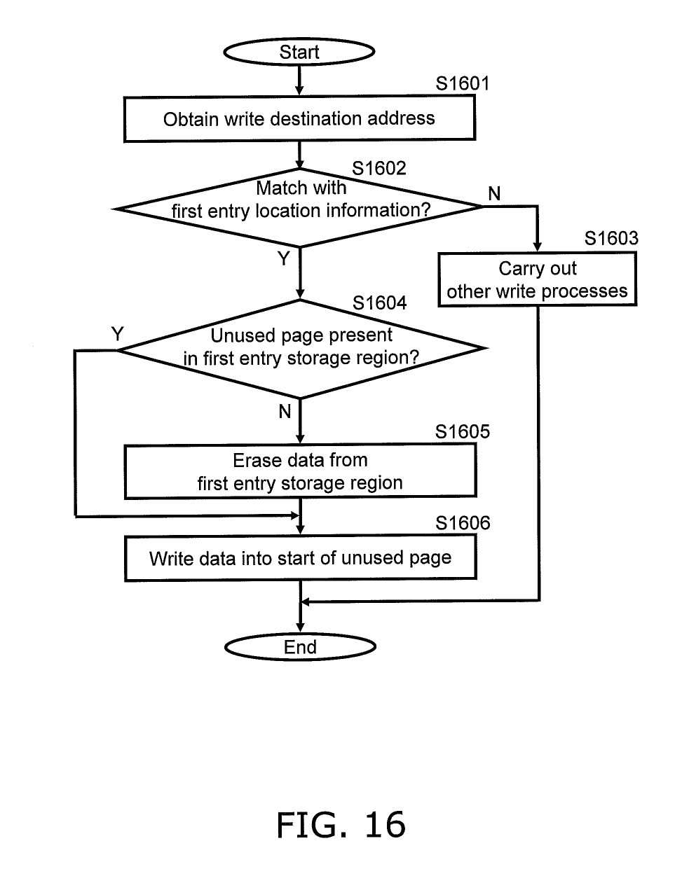

Next, a directory entry write process performed by the entry storage control unit 217 according to the present embodiment will be described using FIG. 16. Although FIG. 16 primarily illustrates a write process regarding the directory entry 308 of the first file, the write process regarding the directory entry 308 of the second file is essentially the same. In other words, if in the following process the “first entry location information” is replaced with “second entry location information” and the “first entry storage region” is replaced with “second entry storage region”, the process becomes the write process regarding the directory entry 308 of the second file.

(S1601):

The write destination address is obtained based on a write command issued to the information recording module 2 by the access module 1. Here, the “write destination address” refers to a logical address specified by a write command issued to the information recording module 2 by the access module 1.

(S1602):

The write destination address obtained in S1601 is compared with the first entry location information 411, and it is determined whether the values thereof match. In the case where the values match, the process advances to S1604. However, in the case where the values do not match, the process advances to S1603.

(S1603):

In the case where it has been determined that the values do not match in the determination process of S1602, no write will be made into the first entry storage region 224; therefore, other write processes, such as a process for writing into the user data storage region 223, are carried out, and the processing ends.

(S1604):

In the case where it has been determined that the values match in the determination process of S1602, it is determined whether an unused page is present in the first entry storage region 224. In the case where an unused page is present, the process advances to S1606. However, in the case where an unused page is not present, the process advances to S1605. Here, an “unused page” refers to a page from which the data has already been erased and that therefore holds no valid data, and into which data can be written.

(S1605):

In the case where it has been determined that an unused page is not present in the determination process of S1604, data cannot be written into the first entry storage region 224, and thus the data that is held in the first entry storage region 224 is erased. As a result, an unused page is created within the first entry storage region 224.

(S1606):

Data is written into the start of the unused page. Because it is assumed that the recording of data into the unused page will be carried out continuously from the start of the region, the first unused page that is present when searching the first entry storage region 224 from the start thereof is taken as the unused page for recording.

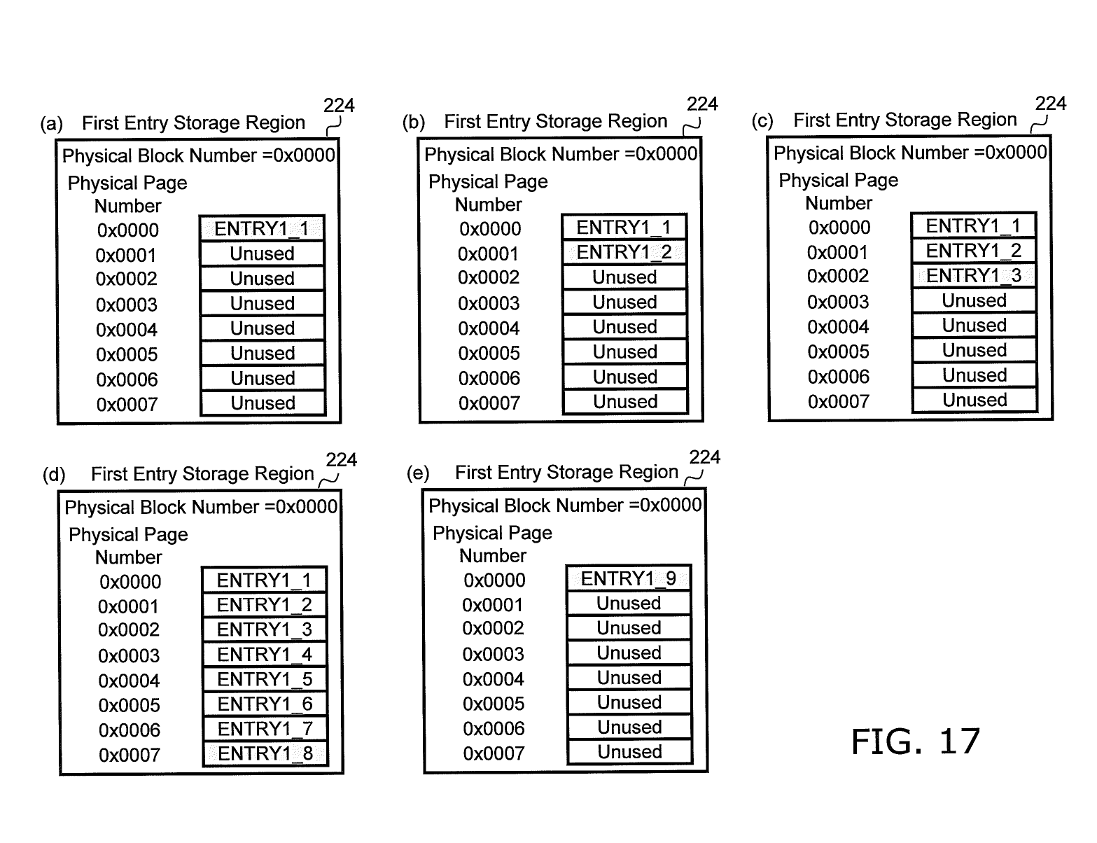

FIG. 17 is a diagram illustrating an example of the state of the first entry storage region 224 according to the present embodiment. In FIG. 17(a), a directory entry 308 (ENTRY1_{—}1) is stored in the starting page of the first entry storage region 224, and all of the pages thereafter are unused pages that have already been erased. Here, in the case where the access module 1 overwrites the data in an ENTRY1_{—}2 in the directory entry 308, the state changes to the state shown in FIG. 17(b). In FIG. 17(b), the data of the ENTRY1_{—}2 is stored in the second page, which is the first unused page. Meanwhile, in this state, the data of the ENTRY1_{—}2, which is shaded, is the newest data, and the data of the ENTRY1_{—}1 is handled as old data. In other words, in the case where the access module 1 has read out the directory entry 308 in this state, the information recording module 2 outputs the data of the ENTRY1_{—}2 to the access module 1. Likewise, in the case where data continues to be overwritten in the directory entry 308, the state changes to that shown in FIG. 17(c) and FIG. 17(d). In the case where the access module 1 has overwritten a directory entry 308 (ENTRY1_{—}9) in the state shown in FIG. 17(d), the data in the first entry storage region 224 is erased through the process of S1605, and the data of the ENTRY1_{—}9 is stored in the starting page. In this manner, one page's worth of valid directory entry 308 data is continuously held in the first entry storage region 224, and thus wasteful copy processes are not carried out in the write processes.

As described thus far using FIGS. 16 and 17, the entry storage control unit 217 according to the present embodiment stores the directory entry 308 in the first entry storage region 224 or the second entry storage region 225 using the first entry location information 411 or the second entry location information 412 communicated by the address management information setting processing unit 104 of the access module 1. Through this, wasteful copy processes are prevented from occurring during the writing of the directory entry 308, making it possible to write the directory entry 308 at a high speed.

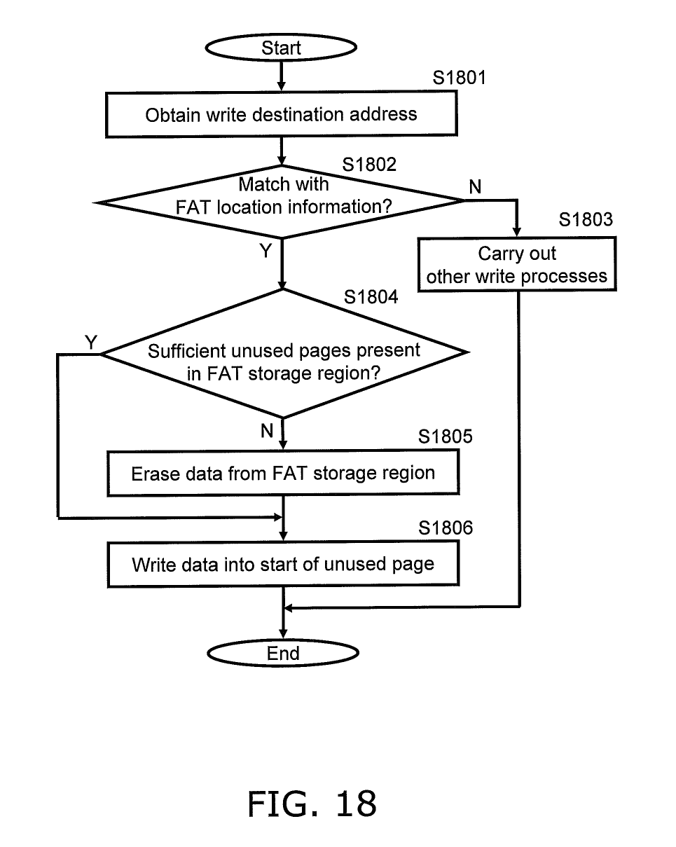

Next, an FAT write process performed by the FAT storage control unit 218 according to the present embodiment will be described using FIG. 18. Because the processing illustrated in FIG. 18 is essentially the same as the processing illustrated in FIG. 16, detailed descriptions thereof will be omitted. FIG. 18 differs from FIG. 16 in that the “first entry location information” has been replaced with “FAT location information”, the “first entry storage region” has been replaced with “FAT storage region”, and the write processing is carried out not in units of single pages but in units of multiple pages.

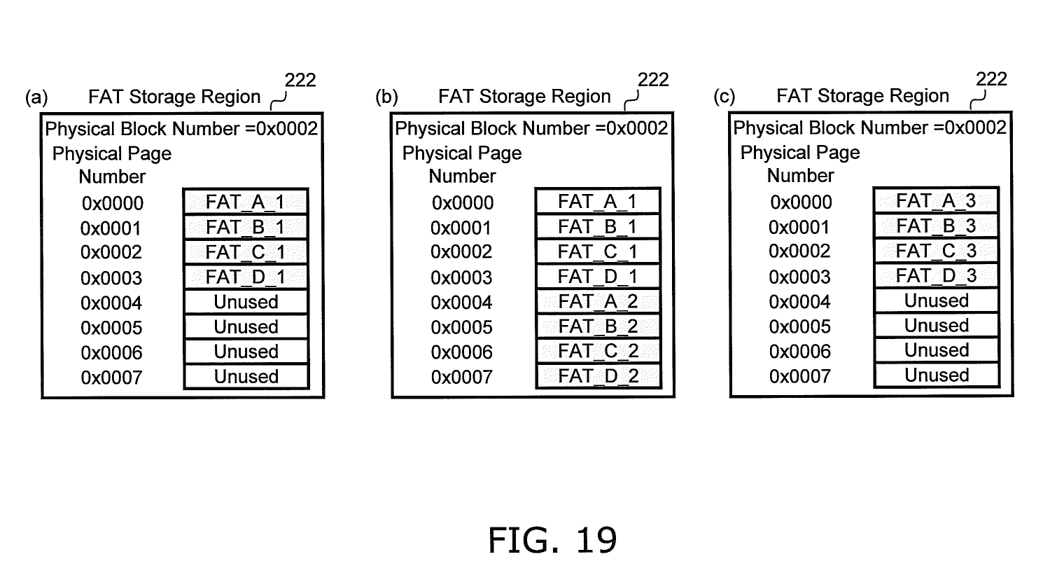

FIG. 19 is a diagram illustrating an example of the state of the FAT storage region 222 according to the present embodiment. In FIG. 19(a), data of the FATs (305 and 306) is stored in the first four pages of the FAT storage region 222. In other words, this example indicates that the size of the FATs (305 and 306) is four pages, and data is stored from an FAT_A_{—}1 to an FAT_D_{—}1. Meanwhile, the remaining four pages in the FAT storage region 222 are unused pages that have already been erased. Here, in the case where the access module 1 overwrites the FAT_A_{—}2 to the FAT_D_{—}2 of the FATs (305 and 306), the state changes to the state shown in FIG. 19(b). In FIG. 19(b), the data from the FAT_A_{—}2 to the FAT_D_{—}2 is stored starting in the fifth page, which is the first unused page. Meanwhile, in this state, the data from the FAT_A_{—}2 to the FAT_D_{—}2, which is shaded, is the newest data, and the data from the FAT_A_{—}1 to the FAT_D_{—}1 is handled as old data. In other words, in the case where the access module 1 has read out the FATs (305 and 306) in this state, the information recording module 2 outputs the data from the FAT_A_{—}2 to the FAT_D_{—}2 to the access module 1. Furthermore, in the case where the data from an FAT_A_{—}3 to an FAT_D_{—}3 has been overwritten in the FATs (305 and 306), the data in the FAT storage region 222 is erased through the process of S1805, and the data from the FAT_A_{—}3 to the FAT_D_{—}3 is stored starting from the starting page. Through this, valid FAT data of the necessary size is continuously held in the FAT storage region 222, and thus wasteful copy processes do not occur during the write processes.

As described thus far using FIGS. 18 and 19, the FAT storage control unit 218 according to the present embodiment stores the FATs (305 and 306) in the FAT storage region 222 using the FAT location information 413 communicated by the address management information setting processing unit 104 of the access module 1 or held in advance as a fixed value. Through this, wasteful copy processes are prevented from occurring during the writing of the FATs (305 and 306), making it possible to write the FATs (305 and 306) at a high speed.

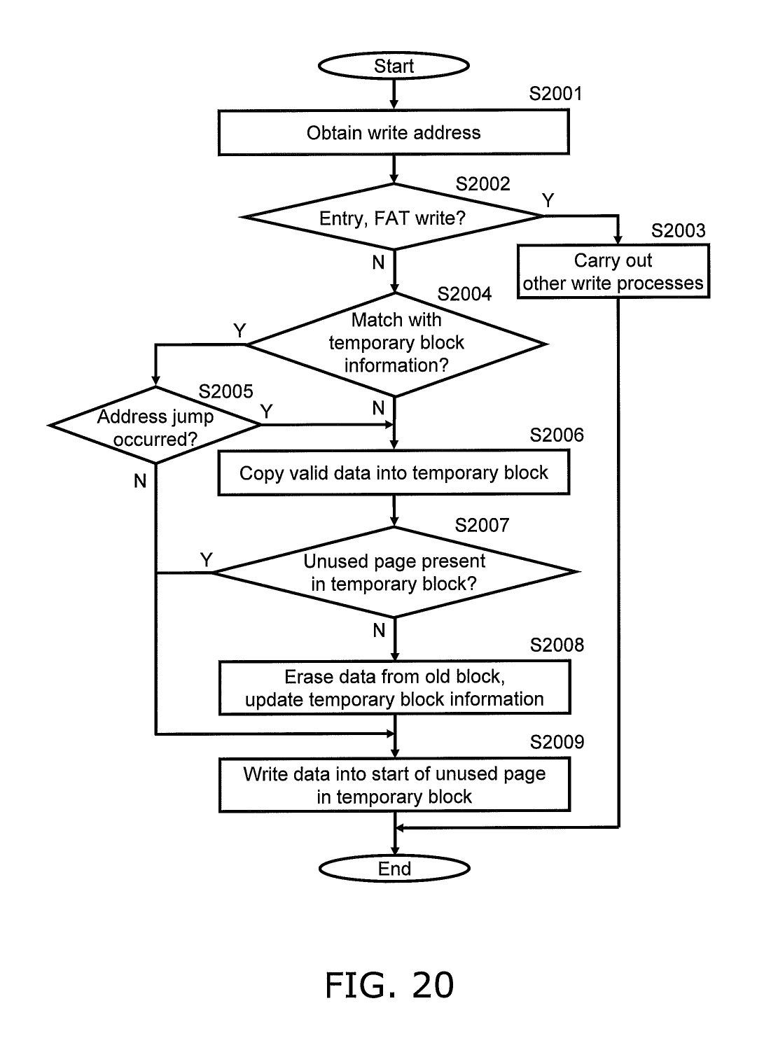

Next, a user data write process performed by the user data storage control unit 219 according to the present embodiment will be described using FIGS. 20, 21, and 22.

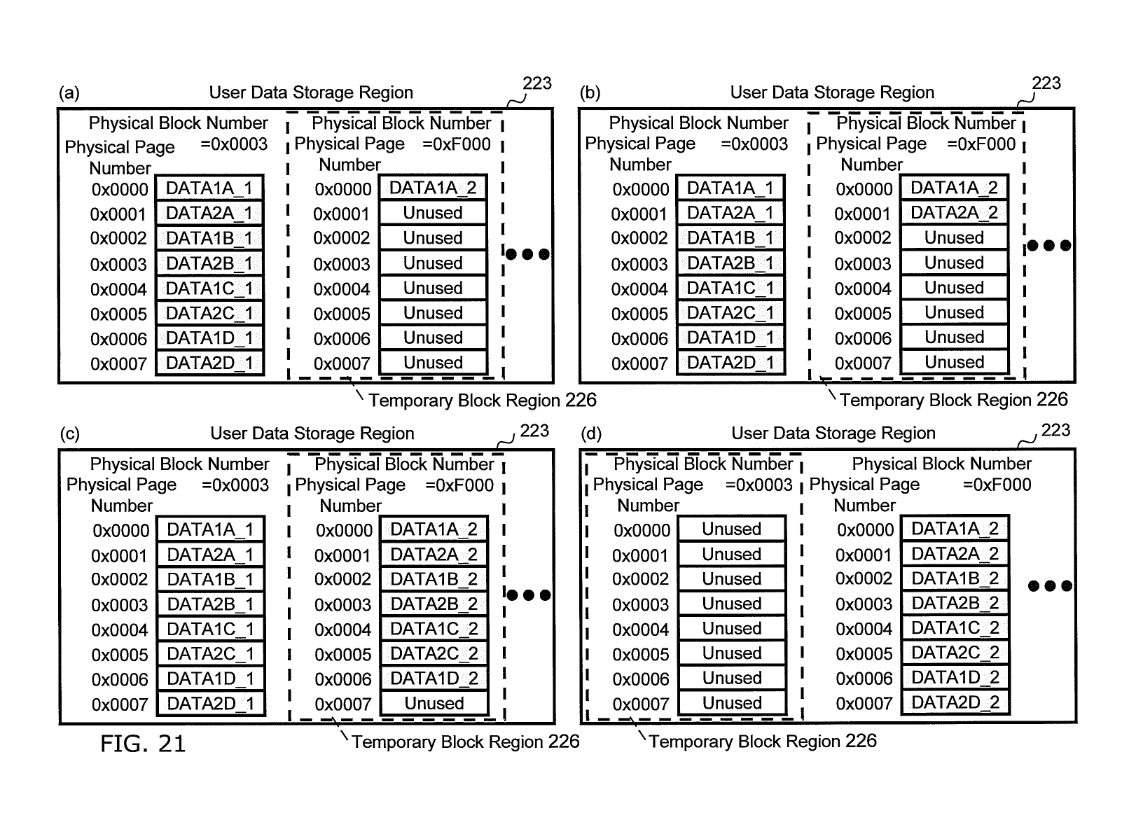

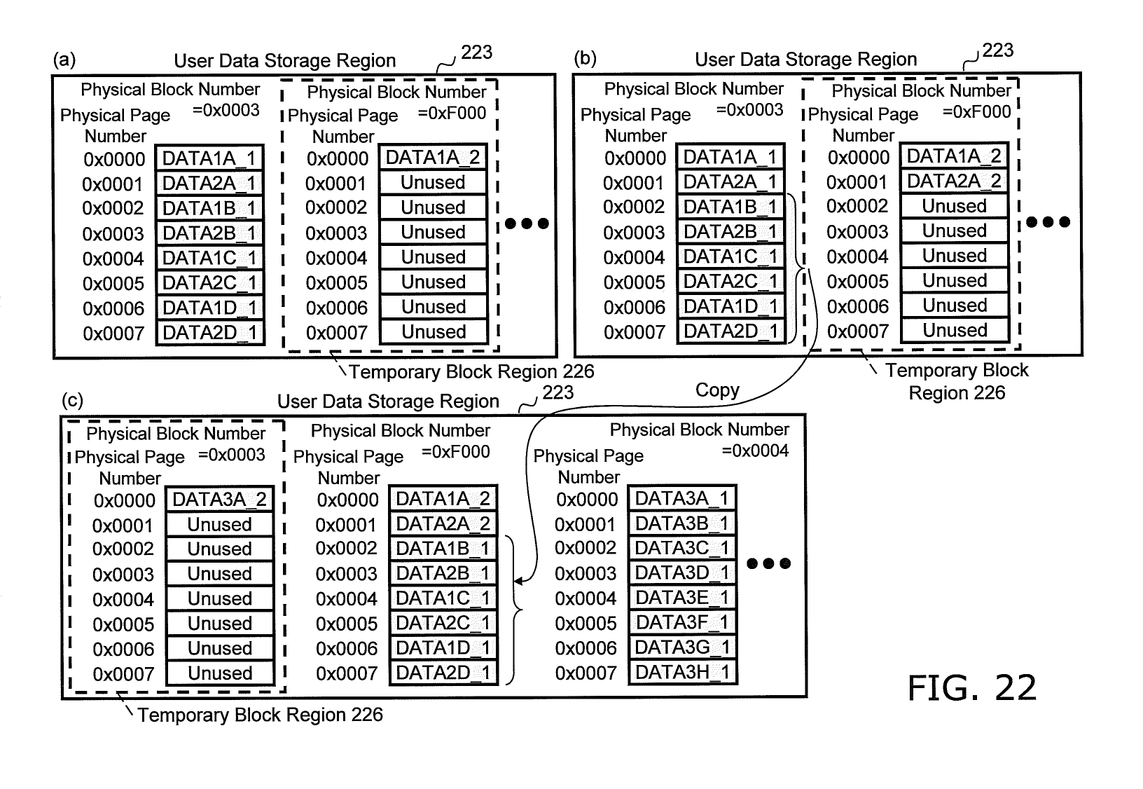

FIG. 20 is a flowchart illustrating the procedure of the user data write process performed by the user data storage control unit 219 according to the present embodiment. FIG. 21 is a diagram illustrating an example of the state of the user data storage region 223 according to the present embodiment. Likewise, FIG. 22 is a diagram illustrating another example of the state of the user data storage region 223 according to the present embodiment.

In FIGS. 21 and 22, the areas surrounded by dotted lines indicate the temporary block region 226. In the present embodiment, when data is written into the user data storage region 223, the data is first written into the temporary block region 226, and when data has been written into the entirety of the temporary block region 226, all the data of a single block has been correctly written. In other words, two physical blocks, or a physical block in a part of which old data and the temporary block region 226 are held, are allocated to the logical address to which the temporary block region 226 is allocated. For example, in FIG. 22(a), two physical blocks, or a physical block number 0x0003 (where only the first page is old data) and a physical block number 0xF000 (where only the first page is new data), are allocated to the same logical address.

(S2001):

The write destination address is obtained based on a write command issued to the information recording module 2 by the access module 1. Here, the “write destination address” refers to a logical address specified by a write command issued to the information recording module 2 by the access module 1.

(S2002):

The write destination address obtained in S2001 is compared to the first entry location information 411, the second entry location information 412, and the FAT location information 413, and it is determined whether the write is a write of the directory entry 308, the FATs (305 and 306), or the like. In the case where the write has been determined to be a write of the directory entry 308, the FATs (305 and 306), or the like, the process advances to S2003. However, in the case where the write has been determined not to be a write of the directory entry 308, the FATs (305 and 306), or the like, the process advances to S2004.

(S2003):

In the case where it has been determined that the write is a write of the directory entry 308, the FATs (305 and 306), or the like in the determination process performed in S2002, the write is not a write made into the user data storage region 223; therefore, other write processes, such as a process for writing into the first entry storage region 224, are carried out, and the process ends.

(S2004):

However, in the case where it has been determined that the write is not a write of the directory entry 308, the FATs (305 and 306), or the like in the determination process performed in S2002, the write destination address obtained in S2001 is compared with the temporary block information 402, and it is determined whether the process is a process for writing into the temporary block region 226. In the case where it has been determined that the process is a process for writing into the temporary block region 226, the process advances to S2005. However, in the case where it has been determined that the process is not a process for writing into the temporary block region 226, the process advances to S2006.

(S2005):

In the case where it has been determined that the process is a process for writing into the temporary block region 226 in the determination process performed in S2004, it is determined whether an address jump will occur within the temporary block region 226. In the case where it has been determined that an address jump will occur, the process advances to S2006. However, in the case where it has been determined that an address jump will not occur, the process advances to S2009.

Here, an “address jump occurring” refers to a case where the address of the last user data written into the temporary block region 226 and the write destination address obtained in S2001 are not sequential. For example, in a state shown in FIG. 21(a), user data (DATA1A_{—}2) is written up to the first page in the temporary block region 226. In this state, in the case where the access module 1 attempts to write one page's worth of user data into a logical address that is one page further from the logical address immediately following the logical address of the DATA1A_{—}2, a process for writing into the third page of the temporary block region 226 occurs, and thus an address jump occurs. In this case, in the present embodiment, it is assumed that the writing into the temporary block region 226 will be carried out with data being written into addresses that continue from the start to the end of the region, and thus the process for copying the one page's worth of data that was jumped is necessary, as indicated in S2006.

(S2006):

In the case where it has been determined that the write destination address and the temporary block information 402 do not match in the determination process of S2004, the case where it has been determined that an address jump has occurred in the determination process of S2005, or the like, a data copy process is carried out. FIG. 22 illustrates an example in which the write destination address and the temporary block information 402 do not match. In this case, the state changes from the state shown in FIG. 22(b) to the state shown in FIG. 22(c) immediately after the data copy process. In other words, the state shown in FIG. 22(b) indicates a case in which the access module 1 has written user data into the region of a logical address corresponding to a physical block number 0x0003, and FIG. 22(c) indicates a case in which the access module 1 has written user data into the region of a logical address corresponding to a physical block number 0x0004, from the state illustrated in FIG. 22(b). In this case, the temporary block region 226 is reallocated in order to carry out recording into the region of the logical address corresponding to the physical block number 0x0004, and thus it is necessary to first complete the recording into the region of the logical address corresponding to the physical block number 0x0003. For this reason, the valid data from DATA1B_{—}1 to DATA2D_{—}1 stored in the physical block number 0x0003 is copied into unused pages in the physical block number 0xF000, which is the temporary block region 226.

(S2007):

It is determined whether an unused page is present in the physical block to which the temporary block region 226 is allocated. In the case where an unused page is present, the process advances to S2009. However, in the case where an unused page is not present, the process advances to S2008. For example, when data is copied into the physical block 0xF000 through the process indicated in S2006 and illustrated in FIG. 22(c), and the unused pages are used up as a result, it is determined that an unused page is not present in the temporary block region 226.

(S2008):

In the case where it has been determined, in the determination process of S2007, that an unused page is not present in the physical block to which the temporary block region 226 is currently allocated, the data contained in a physical block that stores only old data is erased, and the temporary block information 402 is updated so that that physical block is used as the new temporary block region 226. For example, in the example illustrated in FIG. 22(c), the data of the physical block that has the physical block number 0x0003, which is a physical block that stores only old data, is erased, and that physical block is then used as the new temporary block region 226. In this manner, the temporary block region 226 sequentially moves to new physical blocks.

(S2009):

The user data is written into the start of the unused pages within the temporary block region 226, and the process ends. Because it is assumed that the recording of data into the unused pages will be carried out continuously from the start of the region, the first unused page that is present when searching the temporary block region 226 from the start thereof is taken as the unused page for recording.

The processing illustrated in FIG. 20 is essentially the same as the user data write process performed by the conventional information recording module 2. However, when the access module 1 according to the present embodiment records user data, the recording is carried out by padding data of a fractional size and recording the data into sequential addresses using a unit that is a multiple of the size of the unit of the recording processing, even in the case where multiple files are recorded in parallel. For this reason, a copy process such as that shown in FIG. 22 does not actually occur, and user data is stored in a continuous manner from the beginning to the end of the temporary block region 226, as shown in FIG. 21; thus wasteful copy processes do not occur.

As described thus far using FIGS. 20, 21, and 22, the user data storage control unit 219 according to the present embodiment carries out a process for writing data into the user data storage region 223 using the temporary block region 226. However, the processing performed by the access module 1 according to the present embodiment prevents the occurrence of wasteful copy processes when writing the user data, and it is thus possible to write the user data at a high speed.

As described thus far, in the case where the access module 1 and the information recording module 2 of the present embodiment are used in combination and multiple files are recorded in parallel, wasteful copy processes occurring in the information recording module 2 are eliminated and a drop in the recording speed is prevented, which makes it possible to write file data into the information recording module 2 in a fast and stable manner.

Although the present invention has been described based on the aforementioned embodiment, it should be noted that the present invention is of course not limited to the embodiment discussed above. Many variations can be made within a scope that does not depart from the spirit of the present invention. The numerical values denoted in the present embodiment are exemplary, and other values may be used instead. For example, the values of the physical block size, page size, and so on are all exemplary, and those sizes are not intended to be limited to the values denoted in the present embodiment.

Meanwhile, although the configuration of the controller 21 of the information recording module 2 has been described using FIG. 1, a different configuration may be employed. For example, the CPU 212, RAM 213, and so on within the controller 21 may be disposed outside of the controller 21, and conversely, other constituent elements may be provided within the controller 21.

In addition, although FAT 16 has been described as an example of the filesystem in the present embodiment, a different filesystem may be employed.

In addition, it is not necessary for the number of non-volatile memories 22 used in the information recording module 2 to be limited to one, and multiple memories may be used in combination. The speed of the write process can be further increased particularly in the case of a configuration in which data is written into multiple non-volatile memories 22 in parallel.

In addition, a method has been described in which the file size in the directory entry 308 is adjusted in the process indicated in S1304 in the case where the data shaping processing unit 105 has padded the data to be written. However, in the case where the file format of the video file, the still image file, or the like supports a function for adding padding, the data may be stored directly using the post-padding size as the file size of the directory entry 308.

In addition, although a case in which the size of the unit of the recording processing is the same as the page size has been described as an example, a different size may be used as the size of the unit of the recording processing. For example, a multiple of the cluster size, which is the size of the unit by which data is managed in the filesystem, may be used as the size of the unit of the recording processing.

In addition, although the present embodiment describes an example in which two files are written in parallel, the configuration may be such that three or more files can be written in parallel. Such a configuration can be accommodated by increasing the number of entry storage regions to the number of files to be written in parallel.

In addition, although the present embodiment describes an example in which two files are written in parallel, in the case where the filesystem supports a function for storing metadata of a file separately from the file data, the second entry storage region of the present invention may be used to store the metadata of the file. For example, in the NTFS filesystem, extension information called a “named stream” can be stored separately from the file data as metadata regarding that file. For this reason, the second entry storage region of the present invention can, for example, be used to store the named stream information of that file. Through this, such metadata of files can also be recorded at a high speed.

In addition, although a method has been described in which a process for setting the entry location information is carried out in S1301 of FIG. 13 in advance before recording the file data, the entry location information may be communicated from the access module 1 to the information recording module 2 when the directory entry is actually written, such as during the process of S1304.

In addition, although FIG. 14 illustrates a data write process in which only a block in which the entirety of that block is made up of empty regions is obtained and that block is used as the block for writing, a block that contains a number of empty regions equivalent to greater than or equal to a predetermined threshold may be used as a block for writing, as is disclosed in Patent Citation 1.

In addition, although FIG. 19 illustrates an example in which the FATs (305 and 306) are configured from four pages and the entirety of the FATs (305 and 306) are updated at the same time during an update, the entirety of the FATs (305 and 306) do not necessarily have to be updated, and it is acceptable to update only some of the regions within the FATs (305 and 306) that have been updated due to the writing of file data.

### Other Embodiments

Note that the various blocks of the access module (access apparatus) and the information recording module (information recording apparatus) described in the aforementioned embodiment may be implemented as single individual chips by employing semiconductor devices such as LSIs, or some or all of the blocks may be implemented as a single chip.

Note that although the term “LSI” is used here, other names, such as IC, system LSI, super LSI, ultra LSI, and so on are used depending on the degree of integration.

Further, the manner in which the circuit integration is achieved is not limited to LSIs, and it is also possible to use a dedicated circuit or a general purpose processor. FPGAs (Field Programmable Gate Arrays) that can be programmed after the LSI manufacture, configurable processors in which the connections, settings, and so on of circuit cells within the LSIs can be reconfigured, or the like may be used as well.

Furthermore, if other technologies that improve upon or are derived from semiconductor technology enable integration technology to replace LSIs, then naturally it is also possible to integrate the functional blocks using that technology. Biotechnology applications are one such foreseeable example.

In addition, the various processes in the aforementioned embodiment may be realized as hardware, or as software (this includes implementations through an OS (operating system), middleware, or a predetermined library). These processes may also be implemented through processes in which the software and hardware run integrated with one another. It goes without saying that it is necessary to adjust the timing at which to execute each process in the case where the access module (access apparatus) and the information recording module (information recording apparatus) according to the above embodiment are implemented through hardware. For simplicity's sake, the descriptions in the above embodiment have omitted the details regarding the adjustment of the timing of the various signals that arises in the actual hardware architecture.

In addition, the order of execution in the processing methods of the aforementioned embodiment are not necessarily limited to the descriptions in the aforementioned embodiments, and the order of execution can be interchanged without departing from the spirit of the invention.

In addition, although the access module (access apparatus) and the information recording module (information recording apparatus) have been described as separate apparatuses (separate modules) in the aforementioned embodiment, the present invention is not limited thereto, and the access module (access apparatus) and the information recording module (information recording apparatus) may be configured within a single apparatus.

### INDUSTRIAL APPLICABILITY

An access module according to the present invention includes an address management information setting processing unit that communicates, to an information recording module, information regarding the storage location of a directory entry, and a data shaping processing unit that pads file data when writing fractional data such as the end of a file and writes the file data into the information recording module. The information recording module according to the present invention, meanwhile, includes an entry storage control unit, an FAT storage control unit, and a user data storage control unit that update a storage destination and a storage method in accordance with a data type specified to be written by the access module. By combining the access module and the information recording module, in the case where multiple files are recorded in parallel, wasteful copy processes occurring within the information recording module can be eliminated and a decrease in the recording speed prevented, and the file data can be written into the information recording module in a stable manner and at a high speed. Such an access module is optimal for devices that handle digital content such as music, still images, video, and so on, and particularly in such devices that are required to record content data into an information recording module in real time and such devices that record multiple files, such as video files and still image files, simultaneously; thus the access module can be employed in PC applications, audio recorders, DVD recorders, HDD recorders, video cameras, digital still cameras, mobile telephone terminals, and so on. Meanwhile, the information recording module according to the present invention can be employed in removable media such as memory cards, internal recording devices, or the like that store the stated digital content.

### REFERENCE SIGNS LIST

1 access module
2 information recording module
11, 212 CPU
12, 213 RAM
13 information recording module interface
14, 214 ROM
21 controller
22 non-volatile memory
101 application control unit
102 filesystem control unit
103 information recording module access unit
104 address management information setting processing unit
105 data shaping processing unit
211 access module interface
215 non-volatile memory interface
216 address management information
217 entry storage control unit
218 FAT storage control unit
219 user data storage control unit
221 entry storage region
222 FAT storage region
223 user data storage region
224 first entry storage region
225 second entry storage region
226 temporary block region
301 filesystem management information region
302 user data region
303 master boot record partition table
304 partition boot sector
305, 306 FAT
307 root directory entry
308 directory entry
401 data type information
402 temporary block information
403 address conversion information
411 first entry location information
412 second entry location information
413 FAT location information

1. An access module that accesses an information recording module having a non-volatile memory that stores data, the access module comprising:
an address management information setting processing unit that communicates in advance, to the information recording module, location information indicating a region in a logical address space, the region in which data of a predetermined data type is stored; and
a data shaping processing unit that, in the case where the data size of valid data of file data to be recorded into the information recording module is smaller than a predetermined unit of recording processing, changes the size of the file data to the size of the predetermined unit of recording processing by adding arbitrary data to the file data, and records the file data into the information recording module.

2. The access module according to claim 1,
wherein in the case where file data of multiple files is recorded into the information recording module in parallel, the data shaping processing unit records the file data of the multiple files into the information recording module while arranging the file data of the multiple files in an arbitrary order such that addresses of the file data are continuous within a predetermined continuous region size.

3. The access module according to claim 1,
wherein the predetermined data type is filesystem management information that includes either information on the name of the file data to be recorded or information on the file size of the file data to be recorded.

4. The access module according to claim 2,
wherein the predetermined data type is filesystem management information that includes either information on the name of the file data to be recorded or information on the file size of the file data to be recorded; and
the address management information setting processing unit communicates in advance multiple pieces of location information indicating regions in which a plurality of pieces of the file system management information are stored to the information recording module.

5. The access module according to claim 1,
wherein in the case where arbitrary data has been added to the file data recorded into the information recording module, the size of the valid data before the arbitrary data was added is set as the file size in the filesystem management information that includes information on the file size of the file.

6. (canceled)

7. The access module according to claim 2,
wherein the predetermined continuous region size is a multiple of the physical size of the unit of data erasing processing of the non-volatile memory included in the information recording module.

8. An information recording module comprising:
a non-volatile memory that stores data;
address management information that holds location information indicating a region in a logical address space, the region in which is stored data of a predetermined data type specified in advance by an external access module; and
an entry storage control unit that, in the case where it has been determined based on the address management information that data of the predetermined data type is to be recorded, stores the data in a specific region within the non-volatile memory.

9. The information recording module according to claim 8,
wherein the predetermined data type is filesystem management information that includes either information on the name of the file data to be recorded or information on the file size to be recorded.

10. The information recording module according to claim 9,
wherein the predetermined data type is filesystem management information that includes information such as the name, file size, or the like of the file to be recorded; and
the address management information holds multiple pieces of location information indicating regions in which the filesystem management information is stored.

11. The information recording module according to claim 10,
wherein the entry storage control unit allocates a specific region to each piece of location information, indicating regions in which the filesystem management information is stored, that is held in the address management information, and stores the filesystem management information in the specific regions.

12. The information recording module according to claim 8,
wherein the address management information further includes location information of a region that stores data of a second data type that is different from the predetermined data type; and
the entry storage control unit further performs a process that, in the case where it has been determined based on the address management information that data of the second data type is to be recorded, stores the data in a specific region within the non-volatile memory that is different from the region in which the data of the predetermined data type is stored.

13. The information recording module according to claim 12,
wherein the second data type is region management information used by a filesystem.

14. A controller that controls an information recording module having a non-volatile memory that stores data, the controller comprising:
an entry storage control unit that refers to address management information that holds location information of a region in a logical address space, the region in which data of a predetermined data type specified in advance by an external access module is stored, and in the case where it has been determined that data of the predetermined data type is to be recorded, stores the data in a specific region within the non-volatile memory.

15. An information recording system comprising an information recording module and an access module that accesses the information recording module,
wherein the information recording module includes:
a non-volatile memory that stores data;
address management information that holds location information indicating a region in a logical address space, the region in which is stored data of a predetermined data type specified in advance by the access module; and
an entry storage control unit that, in the case where it has been determined based on the address management information that data of the predetermined data type is to be recorded, stores the data in a specific region within the non-volatile memory, and
the access module includes:
an address management information setting processing unit that communicates in advance, to the information recording module, location information indicating a region in a logical address space, the region in which data of the predetermined data type is stored; and
a data shaping processing unit that, in the case where the data size of valid data of file data to be recorded into the information recording module is smaller than a predetermined unit of recording processing, changes the size of the file data to the size of the predetermined unit of recording processing by adding arbitrary data to the file data, and records the file data into the information recording module.
